(19) United States
(12) Patent Application Publication
(10) Pub. No.: US 2007/0036353 A1
(43) Pub. Date: Feb. 15, 2007

(54) Authentication and encryption methods using shared secret randomness in a joint channel

(75) Inventors: Alexander Reznik, Titusville, NJ (US); Debashish Purkayastha, Pottstown, PA (US); Steven Jeffrey Goldberg, Downingtown, PA (US); Robert Lind Olesen, Huntington, NY (US); Marian Rudolf, Montreal (CA); Inhyok Cha, Yardley, PA (US); Alan Gerald Carlton, Mineola, NY (US); Yogendra C. Shah, Exton, PA (US); Shamim Akbar Rahman, Montreal (CA); Rajat Pritam Mukherjee, Montreal (CA); Robert A. DiFazio, Greenlawn, NY (US); Gregory S. Sternberg, Mt. Laurel, NJ (US); Leonid Kazakevich, Plainview, NY (US); Kazimierz Siwiak, Coral Springs, FL (US); Guodong Zhang, Farmingdale, NY (US); Tanbir Haque, Jackson Heights, NY (US); Louis J. Guccione, East Chester, NY (US); Prabhakar R. Chitrapu, Blue Bell, PA (US); Akinlolu Oloruntosi Kumoluyi, Marietta, GA (US); Alain Charles Louis Briancon, Poolesville, MD (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/444,558

(22) Filed: May 31, 2006

Related U.S. Application Data
(60) Provisional application No. 60/685,980, filed on May 31, 2005.
(60) Provisional application No. 60/713,572, filed on Sep. 1, 2005.
(60) Provisional application No. 60/713,290, filed on Sep. 1, 2005.
(60) Provisional application No. 60/715,054, filed on Sep. 8, 2005.
(60) Provisional application No. 60/717,450, filed on Sep. 15, 2005.

(51) Int. Cl. H04L 9/30

(52) U.S. Cl. 380/30

(57) ABSTRACT

The present invention relates to secret key generation and authentication methods that are based on joint randomness not shared by others (JRNSO), in which unique channel response between two communication terminals generates a secret key. Multiple network access points use a unique physical location of a receiving station to increase user data security. High data rate communication data is encrypted by generating a random key and a pseudo-random bit stream. A configurable interleaving is achieved by introduction of JRNSO bits to an encoder used for error-correction codes. Databases of user data are also protected by JRNSO-based key mechanisms. Additional random qualities are induced on the joint channel using MIMO eigen-beamforming, antenna array deflection, polarization selection, pattern deformation, and path selection by beamforming or time correlation. Gesturing induces randomness according to uniquely random patterns of a human user's arm movements inflected to the user device.

### CROSS REFERENCE TO RELATED APPLICATIONS

This application is a non-provisional of the following U.S. provisional application numbers which are incorporated by reference as if fully set forth: 60/685,980 filed May 31, 2005; 60/713,572 filed on Sep. 1, 2005; 60/713,290 filed on Sep. 1, 2005; 60/715,054 filed on Sep. 8, 2005; and 60/717,450 filed on Sep. 15, 2005.

### FIELD OF INVENTION

The invention relates to the area of wireless communications security. Specifically, the invention relates to the generation of secret keys based on wireless channel reciprocity.

### BACKGROUND

Although many of the traditional cryptographic techniques may be applicable to wireless communications, these techniques suffer from the problem that the legitimate parties rely on the computational difficulty of obtaining a key by an eavesdropper, as opposed to its mathematical impossibility. As computational power available for eavesdropper increases, the effectiveness of such methods decreases. Additionally, such methods suffer from a problem that it is usually a simple matter to verify whether a particular guess is correct. Thus, it would be advantageous to construct a cryptographic technique that provides absolute (unconditional) secrecy, rather than one based on computational assumptions. One method for doing so has been well-known in prior art literature based on work of Maurer, Csiszar and Ahlswede and others. A brief description of the approach follows.

Suppose that two parties, Alice and Bob, have access to two sources of randomness, X and Y, which generate independent samples Xᵢ and Yᵢ, at predetermined times indexed by i. Suppose that Alice and Bob wish to generate a “perfectly secret” key by communicating over a public channel to which eavesdropper, Eve, has access. Moreover, Eve may also have access to another source of randomness, Z, generating independent samples Zᵢ. The random source Z is presumably dependent on the random sources X and Y, but not as strongly as X and Y are cross-dependent on each other. Thus, intuitively, Alice and Bob share some advantage over Eve through the stronger inter-dependence of their random sources. Indeed it has been shown that Alice and Bob can exploit this dependence to generate a “perfectly secret” random key.

Without loss of generality, keys can be defined as bit sequences. A perfectly secret random key of length N bits is an N-bit sequence S, shared by Alice and Bob, such that anyone else's (in our case there is only Eve) estimation about what this key sequence can be is roughly equiprobably distributed over all possible N-bit sequences, of which there are 2^{N}.

Let V denote all the communication which takes place over the public channel; n be the number of time instances over which each of the three parties accumulate the output of the random sources they have access to; |S| be the length of the resulting key. Then for any ε>0, we seek a protocol such that for sufficiently large n, the following relationship holds:

$$\frac{1}{n} H ( S \text{\textbar} V , Z ) > \frac{\vert S \vert}{n} - ɛ \qquad Equation 1$$

where H is the entropy of a random variable, well known from prior art literature on information theory. Note that Equation 1 is normalized to a single sampling of the random sources as this is the basic resource for key generation.

The quantity

$$\frac{1}{n} H ( S \text{\textbar} V , Z ) ,$$

which by equation 1 can be equivalently thought of as [|S|/n], is called the secret key rate. Hereafter, the notion of length of secret key and the secret key rate are interchangeable, as appropriate by the context. Namely, whenever a length of a particular secret key is noted, it is to be understood that this is derived based on the observation of some specific quantity (n) of the underlying random variables. Whereas, a secret key rate is noted, the notion is one of the average number of secret key bits per random variable observation.

It is worth noting that there is a critical difference between the above definition of secrecy and the one that most modem crypto systems, including all public-key systems, rely on. Specifically, modern crypto systems rely on the fact that it may be extremely difficult from a computational complexity point of view to guess the crypto key. However, in most of these systems, once the correct guess is produced it is very easy to verify that this is indeed the correct guess. In fact, the work of Maurer and Wolf implies that this must be so for any public-key system, i.e. one where the encryption key is made public, while the decryption key is kept secret. To illustrate the point, consider the following simple example of what a public-key crypto system might be based on, while keeping in mind that most practical systems are much more sophisticated.

Let p and q be two large prime number and let s=pq. It is known that the problem of factoring a product of two large prime numbers is computationally difficult. Thus, one might envision that a public-key cryptography system may be constructed by having the communication destination choose p and q in secret and make their product s publicly available, which is then used as an encryption key for some encryption system which cannot be easily decrypted unless p and q are known. An eavesdropper wishing to intercept an encrypted message would likely start by attempting to factor s, which is known to be computationally difficult. Presumably the eavesdropper would either give up or so much time would pass that the secrecy of the message will no longer be an issue. Note however, that should the eavesdropper guess p, it will quite easily verify that it has the right answer. This ability to know the right answer once it is finally guessed, is what separates computational secrecy from “perfect secrecy”. Perfect secrecy means that even if the eavesdropper guesses the key correctly, it will have no ability to determine that it has indeed done so. Thus “perfect secrecy” is, in a very specific sense, a stronger notion of secrecy than what is prevalent in modern cryptography systems.

It is not obvious that such a protocol generating perfect secrecy in our scenario should exist. Nevertheless its existence, or the existence of many different protocols, has been established in the works of Ahlswede and Csiszar, Csiszar and Narayan and Maurer and Wolf. These prior works also give various upper and lower bounds on the number of random bits that can be generated per single sampling of the random sources under a wide range of assumptions.

The process for generating a perfectly secret key may then be outlined as follows. Alice and Bob first start by utilizing their joint randomness to establish a bit-string sequence S′of whose inherent entropy from Eve's point of view is |S| bits with |S|≦|S′|. This is done using some number of public exchanges between Alice and Bob. In many cases, a single unilateral exchange is sufficient. The exact nature of the exchange depends on the nature of the jointly-random sources (X,Y,Z). This step is usually called information reconciliation.

Alice and Bob then possibly use another set of public exchanges, a single exchange is typically sufficient, to publicly agree on a function which transforms the sequence S′ into a perfectly secret string S. This is typically called privacy amplification. Alternatively, this function may be pre-agreed upon during the system design. In this case, it is assumed that Eve is aware of this.

An additional step occurring before the first step described above called advantage distillation may further be utilized, however as it is not pertinent here, nothing further is described in regards to it.

As specifically applied to a wireless communication system, the process needs further specification. While correlated random sources are a priori difficult to produce without prior communication, the wireless channel provides just such a resource in the form of the channel impulse response. Specifically, in certain communications systems, two communicating parties (Alice and Bob) will measure very similar channel impulse responses when communicating from Alice to Bob and from Bob to Alice (e.g., Wideband Code Division Multiple Access (WCDMA) Time Division Duplex (TDD) systems have this property). On the other hand any party not physically co-located with Alice and Bob is likely to observe a channel impulse response (CIR) that has very little correlation with that of Alice and Bob. This difference can be exploited for generation of perfectly secret keys. Also, it would be of interest to generate some number of perfectly secret bits per CIR measurement. Note that the CIR measurements have to be spaced fairly widely in time so as to be more or less independent.

The ability to generate secret keys and the secret key rate (the number of bits generated per unit of time) depends on the channel properties. Specifically, these depend on the rate of variability of channel. However, in certain scenarios, especially in free space with line-of sight (LOS) between the transmitter and the receiver, the randomness provided by the channel may be insufficient to generate a secret key rate required for a given application. Because each terminal's ability to measure the channel to itself from another terminal typically depends on the latter terminals signaling, (e.g., a transmitted pilot signal), it would be beneficial for the terminals to modify their signaling so as to make the CIR appear more random. However, such an operation only helps if the resulting “artificially created” randomness is such that:
it is highly correlated for the legitimate terminals;
it is highly decorrelated from the eavesdropper terminal—even if the eavesdropper terminal knows precisely the operation that the legitimate terminals use to “add randomness” to the channel.

Zero-knowledge proof background

One well-known technique for authentication is authentication via a zero-knowledge proof (ZKP). Using this technique, the authenticating party (the Prover) is able to prove to the authentication target (the Verifier) that it is indeed a member of the set of valid users of the target's resource without revealing any other information, for example its precise identity.

In prior-art realizations, this technique requires the utilization of two sources of pure randomness: one is available to the prover only; the other is available to verifier only. The security of the approach is computational, not information-theoretic. In many realizations, the ZKP approach consists of 4 steps:
1) A commitment is sent from the Prover to the Verifier.
2) A challenge is sent from the Verifier to the Prover.
3) A response message is computed by the Prover.
4) The Verifier performs a local computation to ensure that the response message makes sense.
   This approach is illustrated as follows by using a discrete logarithm. The discrete logarithm mod some integer n is an operation taking x ∈{1, . . . , n−1}→y∈{1, . . . , n−1} where y=g^{x} mod n for some fixed g∈{1, . . . , n−1}. The assumption of the process is that given y and g, the value of x is computationally secure—i.e., it is computationally prohibitively expensive to try and determine anything about x other then the fact that it is in the range {1, . . . , n−1}. Of course, n and g, which are parameters of the problem, have to be appropriately chosen and we assume that this is so throughout. All operations below are assumed to be mod n, where n is a parameter of the setup.

The goal is for the prover to convince the verifier that it knows x such that y=g^{x}, without giving away any information about x (in the computational sense—i.e., reveal no more then is revealed by the discrete log). Of course, we assume that the verifier has y and g. The four steps above are then implemented as follows:
1) The Prover generates a random r∈{1, . . . , n−1} and sends R=g^{r} to the Verifier.
2) The Verifier generates a random c∈{1, . . . , n−1} and sends it to Prover.
3) The Prover computes s=c+rx.
4) The Verifier checks that g^{s}=Ry^{c}, which verifies the Prover's knowledge of x to it, but, subject to security of the discrete log, reveals nothing about x.

Authentication in Static and Stream Data

Any transaction involves two parties. It can be an end user or end user application and a service provider. The service provider can be another end user, an organization, operators, individuals, etc. Typically a service provider will have an interface for accessing the system, a processing engine and a database. These are the highest level of classification of functionalities. Actual functions can be logically partitioned into any of these functions.

User data is generally in transit or in a static store such as database. Security of the static data can be enhanced if data can be isolated from any illegal or malicious access attempts. Access attempts can be made locally or over the network. Access can be a request-response type transaction or can be for a longer session. With increasing complexity and vulnerability of converged networks, the access credentials and authorizations should be evaluated from the start of the transaction till the end of it in a continuous fashion.

In a transaction, an end user is authenticated at the beginning of the transaction and then authorized or granted certain privileges. The privileges are in the form of read, write, modify, etc. In typical cases, authentication is done once and the user enjoys the privileges throughout the life of the transaction unless there are certain conditions such as inactivity for certain period of time, termination of the transaction, or forced periodic authentication based on timers. Typically a session key is generated and exchanged to maintain the integrity of the session.

This one time authentication for a prolonged transaction, which may involve several accesses to a database, has certain disadvantages. The following are various examples of threat models:
1) Man in the middle attack: Suppose a transaction has been established and a session key has been generated which is exchanged during the transaction. An intruder may sniff the network and extract the session key. If the intruder gets hold of the session key, he/she may act as a legitimate node and intercept the ongoing communication.
2) Modifying/tampering data: In a prolonged session, data packets may be observed for long time and an attempt can be made to modify or tamper it. However, if data is instead authenticated in every exchange, it is very difficult to get the hooks to tamper or modify data.
3) Key generation and key exchange for applications, which are separated across multiple hops, is a serious problem. There are many ways by which the key can be tapped while in one of the multiple exchanges.
4) Recent techniques for authentication and authorization at the application level, such as periodic authentication, timer based authentication, user ID, and password, are generally configured in software. There are instances where due to carelessness of the administrator, these settings are left to default settings (which may mean access to all) which creates an authentication loophole.

With the convergence of networks, a lot of data will be generated autonomously at different nodes and transmitted over the network. Sensor networks will generate streams of data, which will be stored in the database. There will be increasing demand for continuous queries on the data stream and real time responses. Analyzing continuous, high-volume data feeds poses a special challenge for applications as varied as automated financial-market trading, security-incident detection, and weather forecasting. These applications all use analytically discovered patterns to generate predictions, yet the value of these predictions is degraded by long processing times. Under such scenarios of a converged network and stream of user data, authenticating each query at the application level and determining authorization will impact the performance.

The threat model for stream data is similar to the static data as described before, but there are a few differences such as:
1) Attack on data integrity: Data can be injected or modified.
2) Attack on confidentiality/privacy: Continuous stream makes it easy to eavesdrop on a channel.
3) Attack on data validity: Attacker can inject or update data, compromising the validity of query response.
4) Denial of service: Attacker can exhaust bandwidth by inserting a node/sensor, which emits random data at a very high rate.

WLAN

In wireless local area networks (WLANs), there is a need to ensure that information transmitted over the air interface is not accessible to any unauthorized user. In an office WLAN setting, the attacker is typically located outside the office (e.g., in the parking lot) who is analyzing all transmissions. Similarly, for home users, a potential eavesdropper can easily overhear WLAN transmissions due to the propagation of the radio outside the intended area of reception. Security and privacy of data transmissions is therefore important and of highest concern for the commercial use of WLAN technology. In present state-of-the-art systems, security and privacy is achieved by authenticating and encrypting a users data transmissions between the access point (AP) and the station (STA) (client device). Note that the current state-of-the-art system secures data transmissions between the STA and precisely one network attachment point, i.e., the AP. Current protection mechanisms typically rely on strong authentication and encryption schemes but have an obvious drawback—the attacker gains access to the packet.

### SUMMARY

The present invention relates to authentication methods that are based on a location based joint randomness not shared by others (JRNSO), in which unique channel response between two communication terminals is exploited to generate a secret key.

In a first embodiment, an enterprise network between a wireless access network and a STA or client device takes information about the physical location of the STA into account to further increase security for the user's data beyond basic point-to-point encryption. Multiple network access points are used to send portions of an encryption data packet that can be exclusively translated and reassembled by the STA by virtue of its unique physical relative position to the access points.

In a second embodiment, encryption of a high data rate communication data stream is achieved, wherein a truly random key is generated, a pseudo-random bit stream is generated of equal bit rate as the data stream, and then applied to the main data stream using a one time pad. In a preferred implementation, a standard cipher is updated with JRNSO bits.

In a third embodiment, a configurable interleaving is achieved by introduction of JRNSO bits to an encoder used for error-correction codes. A shared truly random string of JRNSO bits is used to select an interleaving function from among a set of available interleaving functions.

In a fourth embodiment, an alternative ciphering is achieved by using JRNSO in an block cipher or in a public key encryption scheme. In the block cipher example, a strong secret key for the AES algorithm (which is a commonly used block cipher) is regularly updated. A new key schedule is derived using a key expansion routine. In a public key scheme such as RSA, public keys are encrypted with JRNSO bits using a one time pad.

In a fifth embodiment, a zero-knowledge proof function is enhanced by a JRSNO key of k values which provides an additional known value k which is helpful to verify the computations performed by the Verifier and the Prover during the authentication process.

In a sixth embodiment, security is enhanced for access to databases of user data based on JRNSO-based key mechanisms.

In a seventh embodiment, a smart antenna/MIMO based technique is used to induce additional random qualities in the channel between two transceivers such that JRNSO encryption is enhanced. Alternatively, the RF path is manipulated by antenna array deflection, polarization selection, pattern deformation, and path selection by beamforming or time correlation.

In an eighth embodiment, gesture-based JRNSO is applied according to uniquely random patterns of a human user's arm movements inflected to the user device. The gestures can be used for authentication of the user to the device as well as enhancing the bit rate of JRNSO encryption, particularly in the initial stages of the communication link.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 shows a conventional network in which an eavesdropper may intersect a bit stream transmitted from an AP to a WTRU;

FIG. 2 shows a network in which each of a plurality of APs transmits PDUs to a WTRU located in a trust zone intersected by the transmission patterns of each of the APs to secure wireless communications in accordance with a first embodiment of the present invention;

FIG. 3 is a block diagram of joint randomness secrecy processing in a lead transceiver;

FIG. 4 is a block diagram of joint randomness secrecy processing in a second transceiver;

FIG. 5 shows a block diagram of a transmitter configured for encryption.

FIG. 6 shows a block diagram of a receiver configured for encryption.

FIG. 7 shows a method flowchart of an block cipher key update using joint randomness not shared by others (JRNSO).

FIG. 8 shows a method flow chart for a ciphering algorithms using JRNSO.

FIG. 9 shows a common scattering scenario between the two ends of a communications link.

FIG. 10 shows a block diagram of a communication system implementation of an eigen-decomposition approach according to the present invention.

FIG. 11 shows an example eigen-value distribution for various eigen-modes during eigen-decomposition.

FIG. 12 shows a relatively flat eigen-value versus frequency channel response.

FIG. 13 shows a relatively dispersive eigen-value versus frequency channel response.

FIG. 14 shows a means of deflecting the RF patterns of an antenna array.

FIG. 15 shows a change in antenna patterns suitable for implementing the invention.

FIG. 16 shows a means for selecting different propagation paths.

FIG. 17 shows two different CIR's due to changing the antenna array coupling to the RF environment.

FIG. 18 shows gesture-based JRNSO enabled communication device.

FIG. 19 shows a signaling diagram for a gesture-based JRNSO communication.

### DETAILED DESCRIPTION OF THE PREFERRED EMBODIMENTS

Although the features and elements of the present invention are described in the preferred embodiments in particular combinations, each feature or element can be used alone (without the other features and elements of the preferred embodiments) or in various combinations with or without other features and elements of the present invention.

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a Node-B, site controller, access point or any other type of interfacing device in a wireless environment.

The present invention covers authentication and encryption techniques enhanced by a joint randomness of a channel response exclusively between two transceivers. This is implemented according to the following embodiments: a location based randomness, a cipher, a zero-knowledge proof configuration, a configurable interleaving, a smart antenna/MIMO induced randomness, and an RF path and pattern manipulation.

Location Based Security

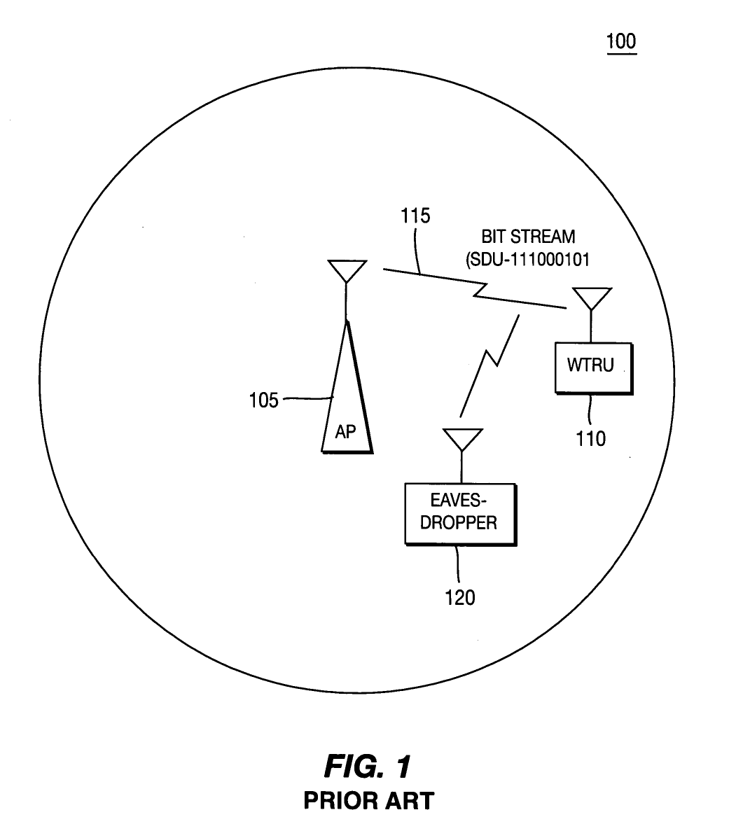

FIG. 1 shows a conventional network 100 which includes an AP 105 and a WTRU 110. When the AP 105 transmits a bit stream 115 to the WTRU 110, an eavesdropper 120 within range of the AP 105 is able to receive the entire bit stream, e.g., 111000101.

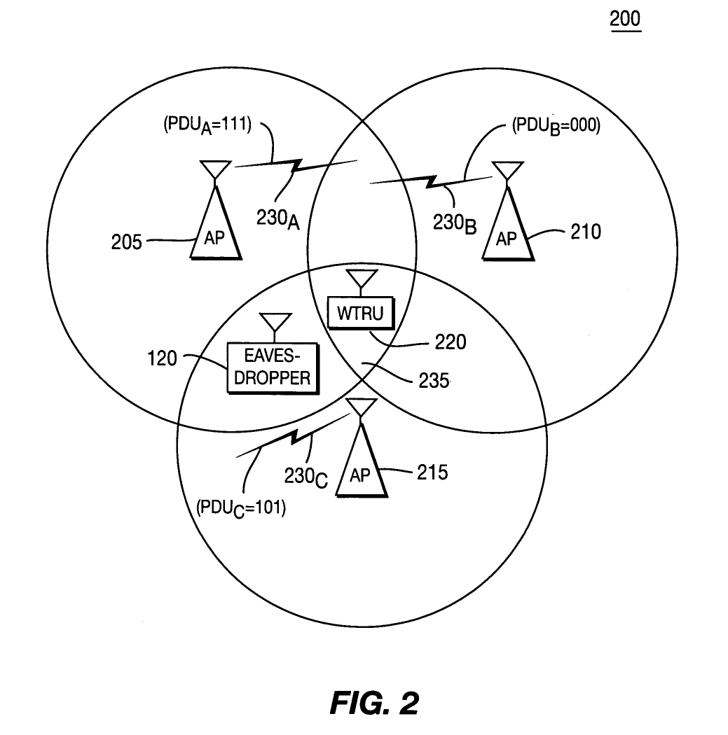

FIG. 2 shows a network 200 including a plurality of access points (APs) 205, 210, 215, a WTRU 220 and the eavesdropper 120 of FIG. 1 in accordance with one embodiment of the present invention. By using a plurality of APs 205, 210, 215, rather than only the sole AP 105 in the conventional network 100 of FIG. 1, the bit stream 115 is secured from being decrypted by the eavesdropper 120. The WTRU 220 is located at the intersection 235 of the transmission patterns of the APs 205, 210 and 215, whereby the WTRU 220 will receive a first fragment 230_{A} of the bit stream 115 , “111”, from the AP 205, a second fragment 230_{B} of the bit stream 115, “000”, from the AP 210, and a third fragment 230_{c} of the bit stream 115, “101”, from the AP 215. Each fragment 230_{A}, 230_{B}, 230_{c} is referred to as a packet data unit (PDU) and the original bit stream “111000101” is referred to as a service data unit (SDU). The WTRU 220 then reassembles the entire encrypted SDU from the three PDUs 230_{A}, 230_{B} and 230_{C}. Since the eavesdropper 120 is not physically located at the intersection 235 of the transmission patterns of the APs 205, 210 and 215 such that all of the fragments 230_{A}, 230_{B}, 230_{C} are received at an error rate comparable to that of the WTRU 220, the eavesdropper 120 is unable to decipher the entire bit stream 115, (even with knowledge of a secret key).

In the network 200 of FIG. 2, the SDU that is deciphered by the WTRU 220 is 111000101, where PDU_{A}=111, PDU_{B}=000 and PDU_{C}=101. If the eavesdropper 120 manages to decipher two out of the three PDUs, (e.g., 000 and 101), the eavesdropper 120 will have managed to obtain some information which is incomplete but correct.

In an alternative embodiment, any PDUs that the eavesdropper 120 does receive are rendered meaningless if incomplete. For example, the SDU that needs to be sent to the WTRU 220 in the network 200 is 111000101. However, three PDUs that are sent by three different APs 205, 210 and 215, (e.g., PDU1, PDU2, PDU3), are not fragments, as illustrated by FIG. 2, but are instead selected such that the SDU=PDU1 XOR PDU2 XOR PDU3 where PDU1=100110011, PDU 2=110000111 and PDU 3=101110001, such that the SDU=100110011 XOR 110000111 XOR 101110001 =111000101, where XOR is an exclusive-or function. Thus, assuming that the WTRU 220 is located at the intersection 235 of the transmission patterns of the APs 205, 210 and 215, the WTRU 235 is able to receive all three PDUs and XOR the PDUs together to decipher the SDU 111000101. If the eavesdropper 120 captures even two of these three PDUS, they are completely meaningless with respect to deciphering the SDU. Alternative mechanisms other than XOR are also possible such as scrambling the packet and sending different bits from different transmitters in such a manner as to render meaningless the transmissions, unless all transmissions are received successfully.

In another embodiment, a location-based authentication mechanism may be incorporated in the network 200 of FIG. 2. The WTRU 220 receives transmissions from the APs 205, 210 and 215, and reports its location to each of the APs 205, 210 and 215. Based upon the reported locations of the WTRU 220 and the APs 205, 210 and 215, each of the APs 205, 210 and 215 may launch a protocol which transmits a sequence of messages, requesting a positive acknowledgement (ACK) or a negative acknowledgement (NACK) from the WTRU 220, at varying effective coding rates higher and lower than the coding rate suggested by the nominal distance between each respective AP 205, 210, 215 and the WTRU 220. Thus, the protocol establishes a criteria which dictates, based on location of the WTRU 220 with respect to the locations of the APs 205, 210 and 215, whether the WTRU may decode transmissions received from the APs 205, 210 and 215. If the location reported by the WTRU 220 is determined to be correct, the protocol will then verify the authenticity of the location of the WTRU 220 by processing ACK/NACK messages received from the WTRU 220 in response to the sequence of messages.

Verification of the authenticity of the WTRU 220 may also be performed such that the WTRU 220, (or a user of the WTRU 220), and the APs 205, 210 and 215 share a common secret. For example, if APs 205, 210 and 215 require the location indicated by the WTRU 220 to be authenticated, the APs 205, 210 and 215 send a “challenge question” via a plurality of PDUs, which may be fragmented or encrypted as described above, such that the “challenge question” would be decipherable by the WTRU 220 only if the WTRU 220 is located as indicated. Thus, the WTRU 220 would not be able to “answer” the “challenge question” unless it was located at a position where the “challenge question” could be deciphered.

Joint Randomness Key Generation

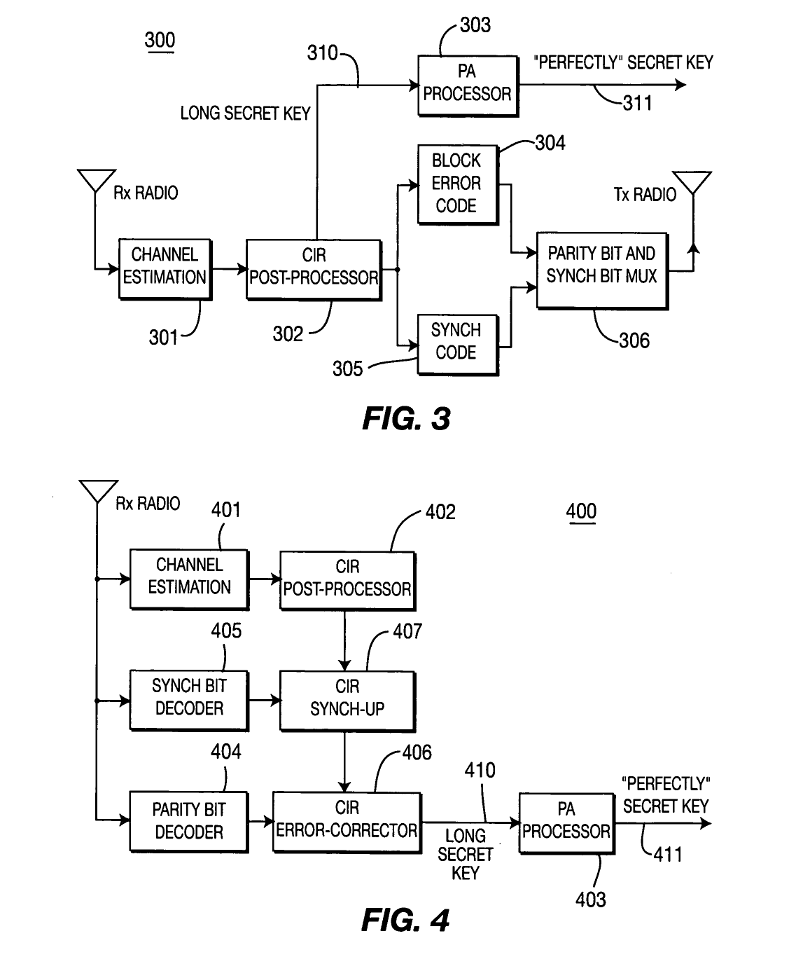

A method for using a joint randomness of a channel to generate perfectly secret keys is disclosed in a related in a jointly owned copending U.S. patent application Ser. No. 11/339,958 which is incorporated by reference as if fully set forth and is outlined in the following discussion. In addressing the issues raised above, it makes sense to start with a point-to-point system (i.e. one where there are only two legitimate parties to the communication). For example, in a communication system for establishing such a secret key between two transceivers 300 and 400, the transceiver 300 is designated as the lead transceiver. The secrecy establishment communication systems for transceivers 300 and 400 are shown in FIG. 3 and FIG. 4, respectively. It should be noted that these would be sub-components of a larger communication system/ASIC and some or all of the processing elements here may be shared for other, non-secrecy-related tasks.

As shown in FIG. 3 and FIG. 4, both transceivers 300 and 400 independently produce an estimate of the channel impulse response (CIR) at channel estimation entities 301, 401 based on the received radio signal. There are prior art methods for performing this step, including the transmission of special signaling by both transceivers for the purposes of aiding this process at the other transceiver. Such signaling can be implemented in various fashions.

The output of the CIR estimation is a digitized representation of the CIR. The CIR estimates may be produced and stored in a number of different well-known ways: in time domain; in frequency domain; represented using an abstract vector space; and so on. Depending on the implementation only partial information about the CIR may be reciprocal and therefore suitable for generation of common secrecy. For example, in certain cases the transceivers may choose to utilize only amplitude/power profile information about the CIR and ignore the phase information.

The CIR may be post-processed by CIR post-processors 302, 402 using a variety of standard methods. The goals of post-processing are to de-noise the CIR as well as to possible remove some redundancy.

The post-processed CIR then needs to be synchronized between the two receivers since the delay-plane references maybe different. Synchronizer coder 305, synchronizer bit decoder 405 and CIR synch-up 407 are shown in FIGS. 3 and 4 as a preferred means for this. Furthermore, as there will be differences in the measurements, these differences need to be corrected. These goals are achievable with block codes using block code entities 304,404, 406 as described in aforementioned U.S. patent application Ser. No. 11/339,958. A transmission from terminal 300 to 400 is required to achieve this.

Finally, once the CIRs have been aligned between transceivers 300 and 400, a Privacy Amplification (PA) process 303,403 is used to extract the same perfectly random shared secret string (key) on both sides. Herein, JRSNO bits are “truly” random or “perfectly” random as opposed to pseudo-random or “computationally” random.

While the prior art method enables one to generate secret keys (bits) from the joint randomness provided by the wireless channel, the rate at which such bits can be generated is typically not large. Rates larger then kilobits per second (of secret bits) cannot be expected. In practice such rates can be significantly lower. Direct use of such bits for encryption (for example via the one-time pad) results in either very low rates since no more than one bit of data per secret bit can be supported, or susceptibility to attacks, such as the frequency attack. Thus, such an approach is not desirable.

Joint Randomness Stream as a Cipher

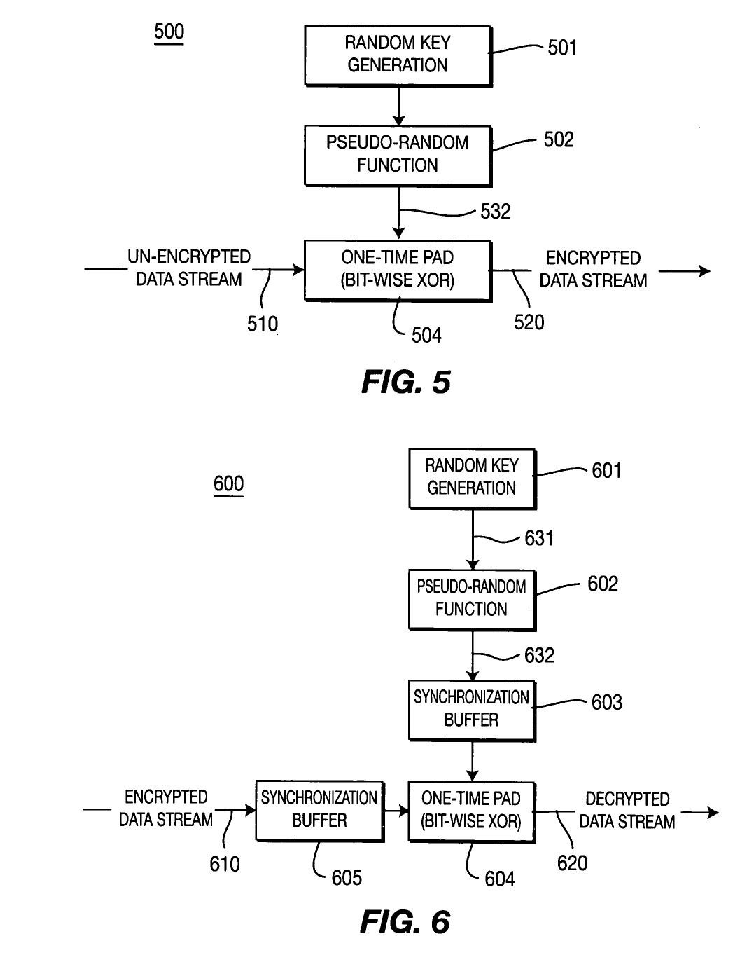

FIGS. 5 and 6 show a security enhanced transmitter 500 and receiver 600 of a communication system, respectively, in accordance with the present invention. As the system relies on the wireless link to generate the random key bits, a wireless communication system is a preferred embodiment and our examples discuss use in current wireless communication standards. However, it should be apparent that the invention is not so limited and can be applied to any communication systems.

In both transmitter 500 and receiver 600, the random key (short string) generated as described above is used to seed a pseudo-random function (PRF) 502,602. The PRF 502, 602 is used to generate a large number of computationally random bits from a short truly random string 531, 631. The object is to generate a computationally random bit stream 532, 632 of equal bit rate as the primary data stream 510, 610. In this, the transmitter 500 and receiver 600 operate identically.

The PRF 502, 602 in general operates as follows. The random key generators 501, 601 produce random bits. Upon becoming available, the random bits form a short perfectly random string 531, 631, and then they are converted into a large number of pseudo-random bits 532, 632 which retain the information-theoretic secrecy properties of the original random bit and introduce additional computational secrecy to “amplify” the number of pseudorandom bits available (equivalently the pseudorandom rate). This means that the notion of refreshing of randomness is inherent here: whenever new absolutely random bits are available, they are used in the PRF to generate the next set/sequence of pseudorandom bits. Thus, the PRF 502, 602 is seeded with the perfectly random key 531, 631.

Finally, a one-time pad 504, 604, such as a bit-wise XOR function, is used to encrypt/decrypt the main data streams 510, 610. Synchronization buffers 603, 605 are used in receiver 600 to synchronize the decryption process. The resulting streams are an encrypted data stream 520 and a decrypted data stream 620.

One effective implementation of a PRF is to use a cipher—either a block or a stream cipher. In its primary purpose, a cipher is used to encrypt some data block or stream (depending on whether this is a block or stream cipher). To do so, it utilizes some strong key which is then used to iteratively generate a non-repeating ciphering pattern. To turn a stream cipher into a PRF, we reverse the roles of the key and the input. The truly random bits are used as a key. Any non-trivially repeating input can be used. It should be known to all parties and may be known publicly without degradation of the computational secrecy of the pseudorandom bits. Such an input is often referred to as a nonce. We then “cipher” the nonce using the absolutely secret key as the strong secret and changing it every time a new one is available. The output of the cipher is then the desired pseudo-random sequence.

To further illustrate how this is done, we illustrate it using the Advanced Encryption Standard (AES)—a powerful and widely used block cipher. It should be clear that this is only an example and any other cipher (block or stream) may be used. The strength of computational secrecy of the pseudorandom bits will depend on: 1) the rate of generation of absolutely random bit—which translates into how often the strong secret is changed and ergo how information-theoretically strong the secrecy is; and 2) the computational strength of the cipher.

The AES is a symmetric (iterated) block cipher. As with all such encryption algorithms, one secret key is used to both encrypt and decrypt a message. Hence, it is assumed that Alice and Bob are sharing the key. Traditional implementations of AES (or any symmetric block cipher) employ only occasional updates of the key. In the current context, it is envisioned that more frequent updates of the key are possible by use of the shared secret bit string whose generation is described in the foregoing sections.

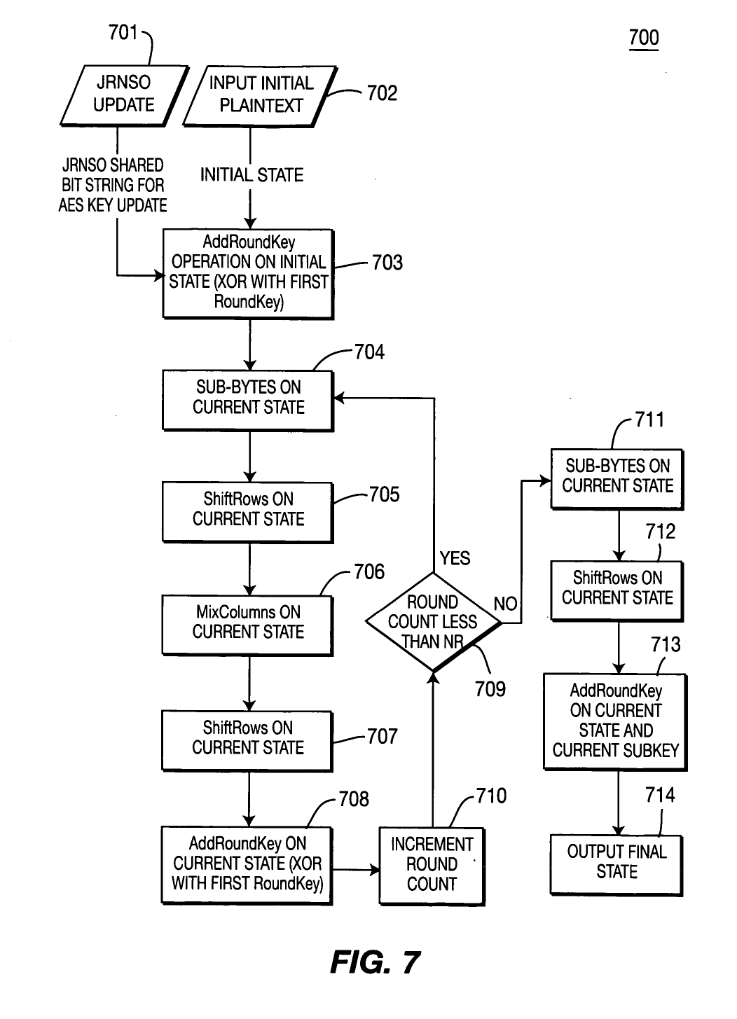

A flow diagram of AES is provided in FIG. 7, which shows all of the basic functions of the algorithm and the insertion point of the JRNSO shared bit string from a top level perspective. The function blocks 702-714 represent the equivalent of the PRF 502 shown in FIG. 5. Details of the key update process are given below.

The AES algorithm operates on plaintext 702 blocks of 128 bits, using key sizes of 128, 192, or 256 bits, depending on whether Nr=10, 12, or 14 rounds (iterations), respectively, are employed. The key is denoted k and its size is denoted Nₖ in 32-bit words. The initial state of the process is the input plaintext block 702 and the final state is the output final state (ciphertext) block 714, also consisting of 128 bits. As indicated in FIG. 7, the states are operated on by a sequence of transformations in each of the Nᵣ rounds. The transformations are:
SubBytes on the current state at block 704, 711 (operates on each bytes of the state separately)
ShiftRows on the current state at blocks 705, 707, 712 (operates on each row of state)
MixColumns on the current state at block 706 (operates on each column of state)
AddRoundKey on the initial state at block 703, on the current state at block 708, and on the current state and current subkey at block 713 (Adds modulo 2 (XOR) the current state bytes with the corresponding RoundKey bytes)
   The current RoundKey is established according to a “key schedule”, which consists of a total of Nᵣ+1 RoundKeys, where each RoundKey is same size as the current state (16 bytes or 128 bits); thus, the total size of the key schedule is 128*(Nᵣ₊₁)/32 words. The AES secret key k makes up the first Nₖ32-bit words of the key schedule.
      The key schedule is generated by means of a key expansion routine, which expands on the key k. To M blocks of pseudo-random bits from a block of K bits of truly random data, an MK nonce is generated and the procedure is performed with K truly random bits as the starting key for M iterations. Preferably, secret key k is XORed with the secret shared string. After that, a new K truly random bits are used to reset the process. The key update rate is based on availability of appropriately sized JRNSO bit string.

As an alternative, we can use the output to feedback into the input to drive the PRF 502, 602. Again, this would be reset whenever sufficient number of new pseudo-random bits are available.

Once this is done, the transmitter 500 takes the pseudo-random bit stream and bit-wise XORs it with the main communication stream 510 (shown as the one-time pad 504 in FIG. 5). This turns an un-encrypted data stream 510 into an encrypted data stream 520. This stream can now be further processed in the communication system for modulation and transmission.

FIG. 6 shows a receiver 600 which performs a second operation of the same secret key to the encrypted stream for undoing the encryption. This is because for any bit-values a and b, we have a ⊕b⊕b=a where⊕ denotes XOR (or mod-2 addition). Thus, the receiver 600 implementation simply mirrors that of the transmitter 500. The only difference is that a synchronization circuit 603, 605 (controlled delay buffer) may need to be applied to either the data stream or the pseudo-random bit stream so as to restore synchronization which is typically lost during transmission. Synchronization itself maybe achieved by a large variety of prior art methods well known to people in this field and is outside the scope of this invention.

As an alternative, the same implementation may be used to encrypt data directly with AES without first generating a pseudo-random stream. In this case, block 701 is still a JRNSO input, block 702 is the data of interest and the rest of FIG. 7 remains the same. However, the decryption process is different here than in FIG. 6 in that an AES decryption algorithm uses the JRNSO sequence as the “strong key.”

It should be understood that the operation here can be applied in a large number of places in the processing chain of a typical communication system. As an example, consider the WCDMA UMTS communication system. This operation maybe applied anywhere in the RLC, MAC, and/or physical layer, including before and after channel encoding and before or after spreading—i.e. we can even apply such ciphering to the chip stream prior to modulation. As a second example, consider and OFDM-based system, such as WLAN 802.11n system. The process described maybe applies anywhere, including prior or after the FFT operation—i.e. to the time-domain or frequency-domain representation, as long as this is done before modulation to the sub-carriers.

The ability to generate a secure pseudo-random bit stream may be of further use CDMA and related technologies where each bit to be communicated is further spread using a string of values (usually binary ones) called chips. While prior art refers to the use of “pseudo-random” sequences to perform such scrambling (see, e.g. use scrambling codes in UMTS), such sequences are “pseudo-random” only in the sense that they replicate the statistical properties of random sequences. They are easy to generate for an adversary and provide no security. We propose replacement of such sequences with true pseudo-random sequence generated as described above. Thus we combine the scrambling of CDMA with the security afforded by true secure pseudo-randomness.

Configurable Interleaving

In a configurable interleaving embodiment, JRNSO is used as a secure parameter for configuration of “configurable” aspects of a communication system. In general, modern communication systems are built to contain many components which are configurable in a sense that the exact behavior of the system depends on some particular parameter. A specific choice of the parameter has little on no effect on the performance delivered. However, all communicating parties must be aware of the specific value of the parameter in order to successfully communication. One example of this is the interleaving patterns both inside and external to modern channel coders. While the specific interleaving pattern usually has little effect on the performance, it must be shared exactly by all communicating parties in order for communication to take place.

Thus, we observe that such parameters, if they can be established in a secure and secret manner between all legitimate parties provide a natural method for securing communications. Any party not in the “know” simply cannot receive the communications stream. Because JRNSO provides for secure establishment of a secret, it is a natural method for doing this.

At the core of our preferred approach is the fact that all modern error-correction codes and wireless communications systems utilize an interleaving function. Additionally, many wireless communications systems use scrambling to create randomness in a data stream. These will be described in more detail below.

By “modern” error-correction codes, we mean codes that are able to approach the Shannon capacity limits. These include Turbo codes, LDPC codes, parallel and serial concatenated coding systems. The interleaving function utilized has the following properties: 1) it is essential to the performance of the code; and 2) it has to appear to be rather random. Caution is to be exercised to avoid some interleaving functions that result in poor code performance and should not be used. Such poor performing interleaving functions are easily identifiable as they tend to have well defined structure (e.g., no interleaving, shift functions, etc.) There are very few of these.

The interleaving function is preferably utilized to interleave input into separate encoders which are concatenated either in a serial or parallel manner. Some examples of these types of codes include turbo codes and standard concatenated convolutional. To produce turbo codes in this embodiment, two convolutional encoders are concatenated in parallel and the input into one of the two is interleaved. Alternatively using a serial concatenation, the output of the convolutional encoder is interleaved and then input into a Reed-Solomon encoder.

105 Alternatively, the interleaving function maybe used to connect input and/or output bits to “local constraints;” where local constraints are typically small simple sub-codes operating on a small sub-set of all code bits. The best-known example of this is the LDPC code, where each output bit must satisfy a small number of local constraints. The local constraints are simple parity checks and the output bits associated with each constraint must have even parity. The interleaving function then defines the association between constraints and output bits. As such it is actually a generalized interleaving functions, as it maps a k-set to an n-set with k and n typically distinct. Nevertheless, it still obeys the properties described above. It must be “random” in appearance. Almost all such functions are and all of these are almost equally good. On the other hand, there are some very obvious bad ones which need to be avoided.

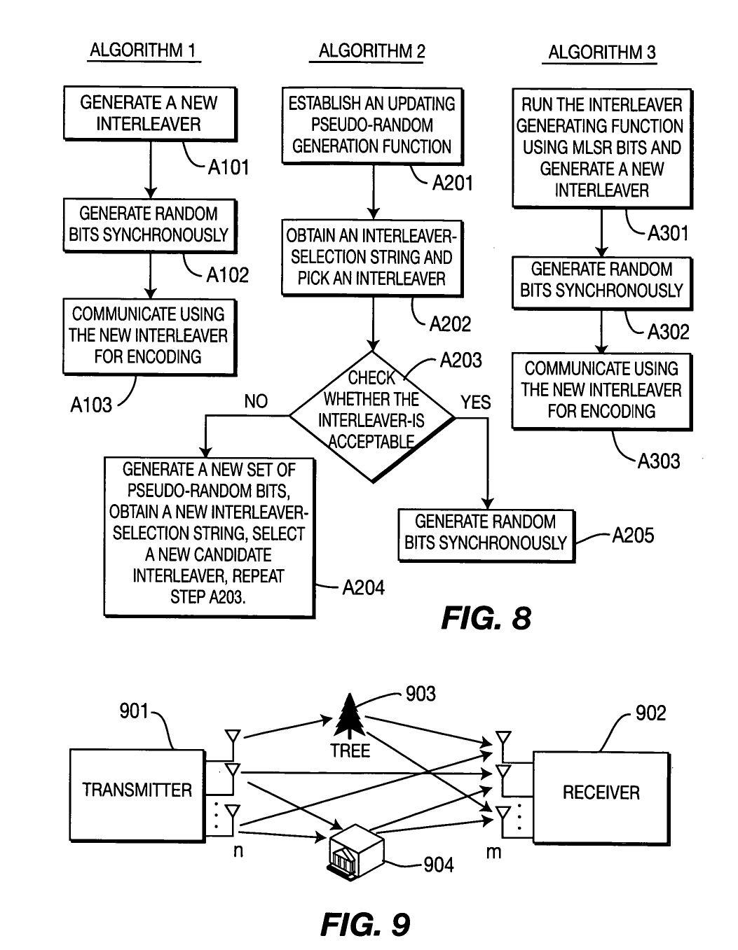

Such properties of modern error-correction codes lead to the following approach for utilization of a small amount of shared randomness: the shared random string is used to select the interleaving function from among the set of all possible functions. Every time a new string with a sufficient number of random bits is available, the interleaver is changed. Because it is extremely difficult to perform decoding absent the knowledge of the interleaver, this delivers a high level of security to the encoding and transmission of data. Depending on the specific approach, one of the three algorithms described below will work. When selecting from among Algorithms 1, 2 or 3, the available interleavers are to be checked for the presence of the poor performing versions. FIG. 8 shows a summary of the following algorithms Algorithm 1, 2 and 3.

107 In a first algorithm, Algorithm 1, a set of acceptable interleavers among all possible ones is readily available and/or easy to define. If so, Algorithm 1 proceeds according to the following steps:
A101. Whenever a sufficient number of random bits are available to generate a new interleaver, do so.
A102. Because both parties generate random bits synchronously, the very fact of their availability provides the necessary synchronization event and little or no further synchronization is needed.
A103. Continue communication using the new interleaver for encoding.

In a second algorithm, Algorithm 2, a set of acceptable interleavers cannot be easily defined a priori among all interleavers. In this case, Algorithm 2 proceeds according to the following steps:
A201. Using public communication, establish an updating pseudo-random generation function. It is not detrimental that a potential attacker is aware of this public communication since the purpose is to simply generate random-appearing strings synchronously on both sides. Note these publicly known pseudo-random bits are to be generated independently from the truly random bits we are utilizing as the true source of randomness.
A202. Whenever a sufficient number of truly random bits are available to generate a new interleaver, combine them with the current pseudo-random string to obtain an interleaver-selection string and pick an interleaver.
A203. Check whether the interleaver is acceptable or one of the poor performers. If it is acceptable, proceed to step A205 below. If it is not acceptable, proceed to step A204 below.
A204. Using the same truly random bits, generate a new set of pseudo-random bits and combine these again to obtain a new interleaver-selection string. Using this string, select a new candidate interleaver and return to step 3. A205. The interleaver is now acceptable—proceed as with step A102 in Algorithm 1.

Algorithm 3 generates a secure interleaver sequence. There are several approaches to generating secure pseudo-random interleaving sequences. For example, given a Galois Field GS(2ⁿ), it is well known that a Maximum Length Shift Register (MLSR) sequence generator with n-bit states will generate all but the zero elements of the field in a fairly random order. In this case, the truly random bits are used to initialize such a generating sequence (i.e., seed the MLSR sequence) and let the interleaver be defined by the mapping from some pre-defined indexing of non-zero field elements to the order in which they are generated. Such interleavers are guaranteed to be good for most applications. Keeping the MLSR example in mind, the following Algorithm 3 steps for generating an interleaving function is available when a simple interleaver generator exists.
A301. Whenever a sufficient number of truly random bits are available to generate a new interleaver, run the MLSR interleaver generating function and generate a new interleaver. The starting phase of the MLSR sequence generator is determined by the truly random bits.
A302. Because both parties generate random bits synchronously, the very fact of their availability provides the necessary synchronization event and little or no further synchronization is needed.
A303. Continue communication using the new interleaver for encoding.

The above interleaving algorithms may be implemented as one or more processors, such as an application specific integrated circuit, which may perform the channel coding or error-corrrection coding as described above.

In wireless communications, especially mobile communications systems, it is common to use a function which randomly distributes the bits in a frame prior to modulation and over the air transmission. A wireless communications signal may suffer from localized, clustered loss of signal due to fading. The result of fading is to introduce conditions when the received signal-to-noise ratio degrades to a level beyond successful recovery of the modulated symbols. This introduces a burst of errors. Modern error correcting codes are very capable of recovering the original bits when the errors are randomly distributed but perform very badly when presented with the same number of errors but in a consecutive burst. Hence an interleaver is typically used to distribute bits coming out of an encoder at the transmitter to distribute the bits. On the receive side, the interleaver is used in reverse fashion to distribute errors introduced by the channel. In a similar manner to the previous application, the interleaver could be randomized to secure communications.

Alternative Cipher

The key issues with modern crypto-systems are that they rely on a rarely updated “strong common secret” (e.g., data encryption standard (DES) and AES), or rely on public-key cryptography approaches (e.g., Rivest Shamir Adleman (RSA)).

114 According to the present invention, random bits effectively enhance these systems. Specifically, the limited number of bits is used to update the strong secret on a regular basis for systems that possess this, or encrypt the public key. In both cases, a very small secret key rate is required and something as simple as a one time pad can be used.

Using the AES example as shown in FIG. 7 for an alternative cipher embodiment, the JRNSO update to the AES cipher occurs each time it makes available a new string of bits equal in size to the length of string k. As the next block of plaintext is about to be encrypted, the new bit string is XORed bitwise with string k, thus producing a new key k′. This security enhancement of regularly updating the strong secret key makes breaking the system a virtual impossibility, even with enormous computational power. The new key k′would almost certainly be operational before any prior key is broken.

Following the key update, a new key schedule is derived using the key expansion routine. Alice and Bob, each using the same shared JRNSO secret string, generate identical key schedules and thus are able to encrypt/decrypt in the usual fashion with a new secret key.

As a second example, a RSA cryptosystem enhancement using JRNSO follows, which shows how public key systems can be enhanced. The encryption and decryption operations are given as follows
y=e_{K}(x)=x^{b}mod n(encryption)
x=d_{K}(y)=y^{a}mod n(decryption)
where x is the plaintext and y is the ciphertext. The key K={n,p,q,a,b}, where n and b are public and a, p and q are private, and n=(pq). Moreover, p and q are both prime numbers and a and b satisfy the following condition:
ab=1 mod(p−1)(q−1) (invertibility)
Thus, if Alice sends a message to Bob, she knows n and b, which is sufficient for the encryption and Bob knows the secret key a, which is used for decrypting the ciphertext.

The public elements of the key k are normally transmitted in the clear. However, using available secret bit strings from JRNSO, as in a one-time pad, the values n and b can be encrypted, via XOR with the string, thus providing an additional layer of security. If Bob transmits these encrypted values to Alice, she is able to decrypt them, via XOR, with the same shared secret bit string.

Zero-knowledge Proof

In the context of the zero-knowledge proof (ZKP) Prover and Verifier, the present invention enhances a ZKP process by the introduction of a JRNSO bit stream. It is assumed here that the Prover and the Verifier have access to a secure and shared random value k. Four sub-cases are considered here, as described below:
Case 1: Other than the random value k, the Prover and the Verifier have access to no other randomness.
Case 2: The Prover has access to an additional random value r.
Case 3: The Verifier has access to an additional random value c.
Case 4: Both the Prover and the Verifier have access to additional random values (r and c respectively).
   Note that Cases 2 and 3 are an “improvement” on Case 1 in the sense that more random resources are present. Case 4 is an “improvement” on Cases 2,3, and the prior art.

It is assumed that a first form of security of the underlying value (x) relies on some secure function f, h, or 1, each of which may be chosen from (its own) family of functions that is indexed in some way (e.g., the base g indexes the family of discrete log functions f(x)=g^{x}). Typically, but not necessarily, one would want g,h,l to be the same functions. For the purpose of this example, discrete log is used throughout and g, h, l are the same functions. Furthermore, it is assumed that each function f, h, l can be either computationally or absolutely secure (i.e., it may either be “extremely hard” or “impossible” to invert it). An example of a computationally secure function is the discrete log function, which is also considered typical.

A second form of security exists in an operation [*] associated with the functions f and h, such that if we have y=r*x and we know f(y) and h(r), then l (x) can be computed from these. This computation should preferably be low complexity. Returning to the discrete log example, such a function is the addition mod n, where if
y=r+x, g^{X}=g^{y}/g^{r}.

Recall the shared secret string k is the only resource available. Because string k is perfectly (not computationally) secret, each step below introduces an element of absolute (as opposed to computation) security into the verification process. The steps below for each case can be utilized selectively or all at the same time. If string k is thought of as a perfectly random bit-string, then to ensure absolute security, different portions of string k must be utilized for each string and each portion must be long enough. Therefore, the ability to use any one or several of these steps depends on the amount of shared randomness available (the range in which string k takes value or equivalently its length when thought of as a perfectly random bit string).

Beginning with Case 1, the following steps are performed according to this embodiment:

1) The Prover computes f(k′*x) , where k′is a sub-string of k, as per discussion above. In the discrete log example, this is y.

2) The Prover and Verifier securely exchange public information f(k′*x). In this case, no other steps are necessary as the Verifier can compute l (x) from h(k′) (since it knows k′) and f(k′*x). This will verify that the Prover indeed knew x. Note in this case, the restriction of security placed on h can be removed.

Turning to Case 2, it is noted that the technique previously described in reference to Case 1 is also applicable here. However, since the Prover now has access to an additionally random r, an additional improvement is available. Recall the following conventional ZPK four steps, as previously described:
1) The Prover generates a random string r ∈{1, . . . , n−1} and sends R=g^{r} to the Verifier.
2) The Verifier generates a random string c ∈{1, . . . , n−1} and sends it to Prover.
3) The Prover computes s=c+rx.
4) The Verifier checks that gs=Ry^{c}, which verifies the Prover's knowledge of x to it, but, subject to security of the discrete log, reveals nothing about x.
   While repeating the above four steps, all or a portion of string k is used in the place of string c. Note that this does not have to be communicated in the open at this point and thus additional security is introduced. Also, all or a portion of string k is used to securely communicate the commitment message (Step 1) and/or the response message (Step 3).

Turning to Case 3, it is noted that the technique described in Case 1 applies as well. Additionally, while repeating the above ZPK four steps, all or a portion of string k is used in the place of string r. Note that this does not have to be communicated in the open at this point and thus additional security is introduced. Also, all or a portion of string k is used to securely communicate the commitment message (Step 1) and/or the response message (Step 3).

Turning to Case 4, it is noted that the techniques described for Cases1, 2, 3 can all be used. In addition, the following further improvement can be introduced: repeating the prior art approach with all or part of the communications being absolutely secured through the use of string k.

This ZKP approach is applicable to WLAN mesh networks. The security approach currently being proposed for a WLAN mesh communication network is to build it on top of the existing 802.11i security solution. The general principle is that when a new node wants to join an existing Mesh it will follow the following steps:
1) The new node (Prover) will perform authentication through its closest (best) neighbor (Verifier) that is already part of the Mesh. Specifically, the Prover will try to Associate with the Verifier which will trigger the Verifier to start the industry standard IETF Extensible Authentication Protocol (EAP). EAP as is well known is an upper layer authentication procedure that is typically run between a Prover, Verifier, and a Radius server.
2) All packets from the Prover to the rest of the Mesh network will be blocked by the Verifier until the Prover is authenticated by the Radius server. This is accomplished through the 802.1x port based standard.
3) Once the Authentication is completed, encryption keys are distributed to the Prover and Verifier to encrypt the data.
4) The Prover then opens the data port of its 802.1x protocol to allow the Prover to send data to the rest of the Mesh. Note that there will be a hop by hop encryption of the packets as it traverses through the mesh.

JRNSO-enhanced databases

With respect to transaction databases used for storing user data, the threats to stream data are reduced or eliminated according to the JRNSO enhancements of the present embodiment, which preferably imputes one or more the following requirements:
1) Any user should be authenticated before accessing the database system.
2) Different levels of authorization are imposed on different streams for different users.
3) Confidentiality and integrity: The system should guarantee that only an intended party could understand the content of the stream. Any unauthorized users cannot modify data.
   There are certain other requirements, like non-repudiation, privacy, validity, and survivability, which may not be relevant in this context.

The following JRNSO-enhanced database systems provide security solutions to the various problems described above in the background.
1) A database system that includes a Management System and an implementation of a JRNSO mechanism whereby random information extracted from a layered communication system, possibly wireline or wireless in association with a regular remote query attempt, is used to establish and continuously update the keying mechanism applied.
The keying mechanism is included within the Database Management System (DBMS) residing on the database server. The secret key generated from the channel characteristics and JRNSO mechanism is made available to the DBMS. The key can be applied towards the exchange of query and data in the following way.
   Every query should be supplied with the secret key generated between the remote client and the server. The secret key can be protected by other known cryptographic methods. The secret key will acts like a “secure token”. The DBMS system extracts the secure token, compares it with the one available with it.
   The same key can be used to encrypt the data returned from the database. This encrypted data is transmitted by the database server to the remote user.
2) A database system that includes a Management System and an implementation of a JRNSO mechanism whereby random information extracted from the Operating System or in relation to the pertinent software processes in association with a local query attempt is used to establish and continuously update the keying mechanism applied.
In this scenario the Database is accessed locally, i.e. the server and the application requesting data are collocated. In this case the communication channel may not be used to generate random key. But the random electrical characteristics associated with the internal communication bus (such as the signal delay, node impedance, signal reflectance due to impedance mismatching etc.), random operating system procedures, device electrical characteristics can be applied to the JRNSO principle of generating secret key between the application and database. This is applicable to any electrical circuit although it is shown for a DBMS and Application. The application and DBMS can use the secret key to authenticate and grant access. The application can supply the secret key, protected with public certificates to authenticate itself. The DBMS uses it as a “secure token” and verifies with the version of the key available to itself. The DBMS can encrypt the data to be returned with this secret key to the requesting application.
3) A streaming database system and an implementation of a JRNSO mechanism whereby random information is extracted from the User Data itself (e.g., Location, Presence, etc.) is used to establish and continuously update the keying mechanism applied.
Sensor network is a best example of streaming data. Every node sends data continuously to a central server. Each node may have many random characteristics (e.g location (in case of mobile nodes), electrical/physical characteristics, battery life, signal strength etc.) All of these random variables can be applied to the JRNSO key generating mechanism to generate a secret key between nodes or between node and the central server. Transmitted data from each node may be encrypted by the secret key.

Beam Selection antenna/MIMO Induced Randomness

Assuming that either transceiver 100 or 200 (or both) has an antenna whose beam may be steered, this embodiment of the present invention may be implemented either directly (using well known prior art antenna approaches) or “virtually” in a MIMO systems by configuring such system appropriately. This embodiment may be utilized in all cases, but is particularly useful when the channel between Alice and Bob has primarily LOS, and little randomness exists.

To mitigate the low-randomness channel, the adaptive antenna is switched between several available beams to determine a preferred beam. A beam is selected based on the amount of randomness that it can generate. We note that in the case when a beam can be steered vertically, pointing the beam so that the signal from the transmitter to the receiver reflects off the ground is preferable as it is likely to create the highest possible random variation into the channel.

Note at this point that the randomization of the channel may in some instances affect the ability to transmit data over such a channel and in this manner negatively affect system performance. To mitigate this, the beam selection may alternatively be done in a manner which takes both the randomness generated and the data throughput into account. The ability to do both is traded off based on system requirements.

In the case where one or both parties are equipped with the ability to generate multiple beams (e.g., though having multiple beam-steering antennae or by having multiple antennae and using MIMO techniques) other approaches to addressing the trade-off between data transmission and secrecy generation are possible. In one approach, different beams are used for the two goals. The data transmission beam is configured so as to support the highest possible throughput (which often results in little channel randomness), while a secrecy generation beam is configured to maximize randomness. This approach extends to implementations having more than two beams.

The transmitter at the multiple antenna station uses distinct pilot signals for each of the different beams. For example, the transmitter may selectively pre-delay the pilot signals placed on different beams and in doing permits the single antenna receiver to separate the different channels as they arrive with different delays or signatures. Alternatively, the transmitter may use different pilot sequences on different beams.

Additional care must be taken when only one of the parties (e.g., the base station in a cellular system) is equipped with multiple antennas. In this case, while one party may be capable of creating multiple beams for its signal propagation to the single antenna party, the single antenna party will observe an overlapped version of these. Thus, the multiple antenna party must take additional care to assist the single antenna party in separating the different signals. One method for accomplishing this is by using pilot signals which are used in most modern communication systems to support channel estimation at the receiver. The transmitter at the multiple antenna station pre-delays the pilot signals placed on different beams and in doing permits the single antenna receiver to separate the different channels as they arrive with different delays or signatures.

Note that the ideas described above may be extended to the case when virtual MIMO is used by the terminals. Virtual MIMO is a technique wherein multiple single antenna terminals cooperate to create a virtual MIMO transmission.

Eigen-Beamforming or Precoding

Returning to the case when one or both stations have multiple antennas, an extremely effective method for creating various subchannels is via eigen-decomposition or precoding as follows.

FIG. 9 shows a block diagram of a MIMO wireless communications channel between a transmitter 901 having n antennas and a receiver 902 having m antennas. The multipath channel response is affected by obstacles 903 and 904. The MIMO channel may be modeled by the following linear equation system,
Y=H_{n,m}X+N
where H is an n by m matrix which characterizes the channel's fading properties from antenna n to/from antenna m.

Note that h_{n,m} may be defined by the following discrete time model for the channel impulse response,

$$h ( τ , t ) = {\sum }_{l = 1}^{L} {σ}_{l} a ( {Ω}_{l} ) {ⅇ}^{{jβ}_{l}} {ⅇ}^{j2π {f}_{Dl} t} δ ( τ - {τ}_{l} )$$

where L is the number of separable multipaths, σ is the multipath amplitude, a(Ωₗ) and βₗ are the array steering vectors, f_{D} is the Doppler, and τ is the time of arrival for the l^{th} multipath.

The correlation between channel taps of antenna elements may be represented by the correlation matrix for H,
R=HH^{H}
By Singular Value Decomposition (SVD) of H, or equivalently the Eigen Decomposition of H^{H}H and HH^{H}, it can be expressed as a matrix of its unitary eigenvectors U,V, and a diagonal matrix of real values Eigen-values D,
SVD(H)=UDV^{H}
where U and V are left and right unitary matrices containing left and right singular vectors of H:
U=eigen-vectors of EVD(H H^{H})
V=eigen-vectors of EVD(H^{H} H)
D=diagonal matrix of real eigen-values of H
   Note that the eigen-values may be ranked by power (λ₁(k)>λ₂(k)>λ₃(k)>λ_{L}(k)) where L is the minimum of the number of transmit and receive antennas min(nm).

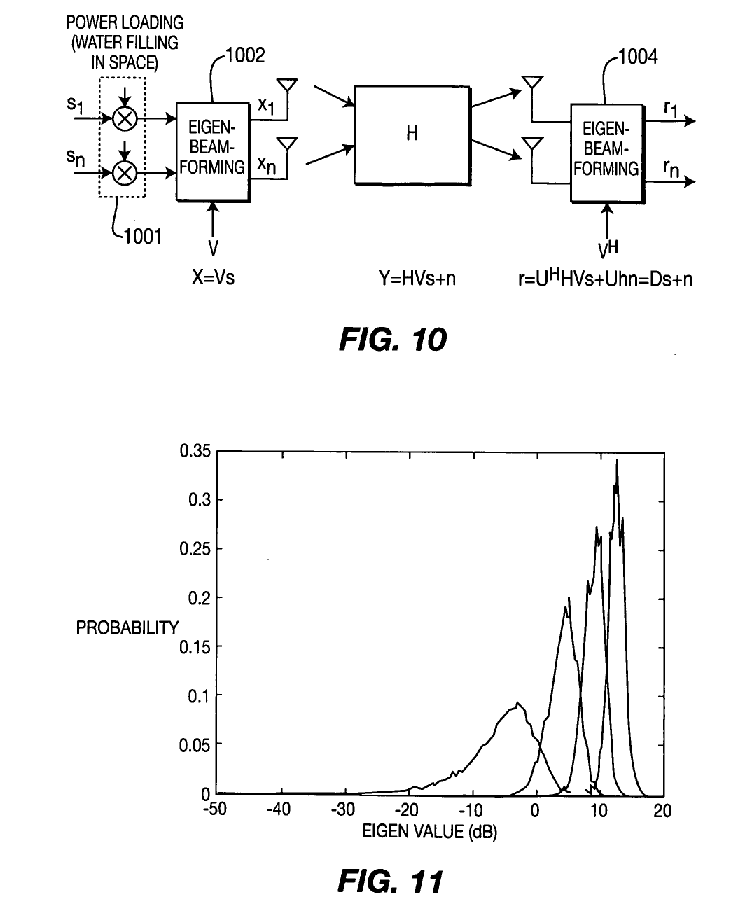

Using the eigen-decomposition approach an optimum (in the Maximum Likelihood sense) MIMO wireless communications channel may be constructed. A block diagram of the elements of the system is given in FIG. 10, where r₁ to rₙ are the received symbols from the MIMO channel, x₁ to Xₙ are the transmit symbols of the MIMO channel. Power loading unit 1001 processes data signals S1 to Sn, eigen-beamforming unit 1002 converts the power loading output values to x₁ to Xₙ values using the V eigenvectors according to X=Vs. Eigen-beamforming unit 1004 processes the received signal using eigenvector UH such that received symbol values rᵢ to rₙ are derived according to the following:

$$r = {U}^{H} HVs + UHN = Ds + N$$

One way to describe the wireless channel using eigen-decomposition is as a set of eigen-modes. The eigen-modes supported by the wireless channel are dependent on the near and far field scattering characteristics at the transmitter and receiver. Eigen-decomposition provides a means to decompose the wireless channel into its dominant and weaker modes. Each mode, represented by its eigen-value, may be expressed as an equivalent wireless SISO channel with fading characteristics that are dependent on the strength of the mode. The weakest eigen-mode has a Rayleigh fading statistic, while stronger modes have respectively narrower distributions.

The eigen-value distribution for various eigen-modes is shown in FIG. 11. Depending on the channel condition, the Eigen-value distribution will vary, but the relative power (strongest to weakest) and spread (narrow to broad) of Eigen-values will typically be consistent.

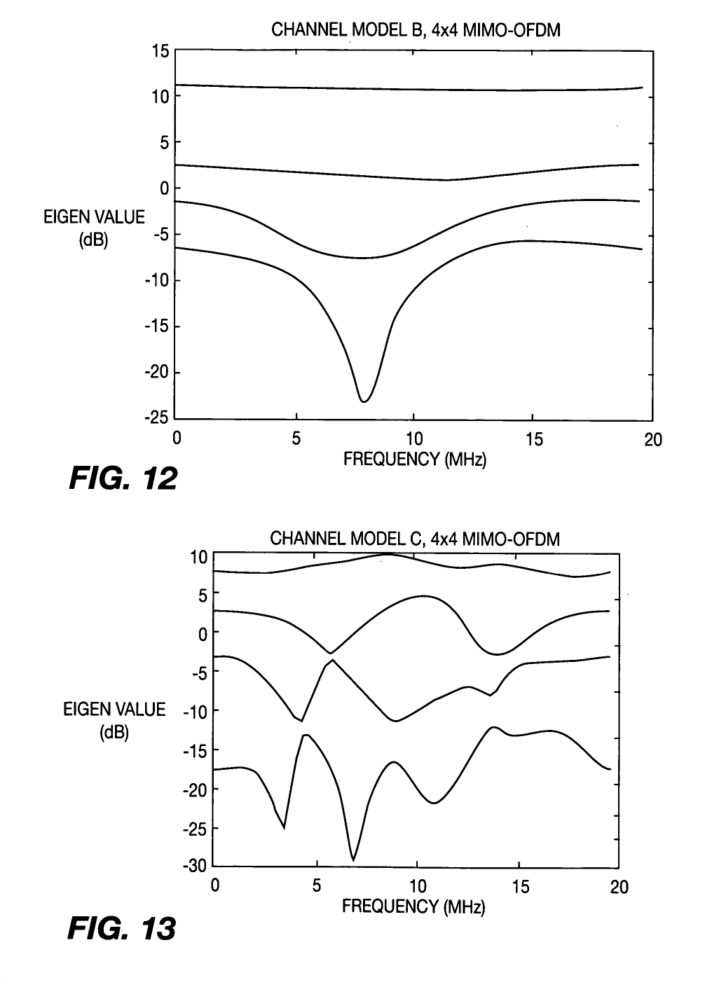

Examples of the Eigen-value variation for two channels is shown in FIGS. 12 and 13. As shown in FIG. 12, channel TGn model B is a relatively frequency flat channel, while channel TGn model C of FIG. 13 is a highly frequency dispersive channel. Note that while the variability of the modes will change as the channel condition changes, the weakest mode will always have a higher variability (e.g., broader distribution) than the stronger one.

Based on the above, it should now be apparent that any one of these modes may be used for secrecy generation. However, whereas the stronger modes are most appropriate for data communication (they have the highest SNR), they are not very good for randomness generation as the variations are low and very slow in time.

On the other hand, the weaker modes tend to have low SNR. This means that little data can be placed on these and in practice depending on the received total SNR they are often unused. However, high variability of the weaker modes makes them excellent candidates for randomness generation. Thus, in this case a natural separation exists between data communication and randomness generation in a way where the two do not negatively impact each other. Accordingly, under this embodiment, the stronger eigen-modes are preferably used for data communication and the weaker ones are preferably used for data generation.

Also note that in some sense the eigen-mode is a “virtual” beam but the beams are orthogonal. However, this case is rather different from the beamsteering approach proposed above in the following sense: the ordering of the modes may change (i.e., a weaker mode may become stronger, etc.)—thus which modes are used for data and which are used for secrecy generation is itself a changeable parameter—unlike the earlier embodiments where the separation of tasks between beams, whether actual or virtual, was stationary. The ordering of the modes may itself be used as an additional secrecy generation parameter.

RF Path and Pattern Manipulations

For JRNSO to make viable use of the CIR, there must be a high correlation of its characteristics between the transceivers 300 and 400 of the desired communication's link, but a poor correlation with any third party. In general, this requires communication paths with reciprocal characteristics and a suitable range of time correlation. The CIR is a function of the RF medium and the coupling to it by the antenna arrays at both transceivers 300 and 400. A third party will in general not measure the same CIR as the primary communicators unless it is within a distance less than a wavelength of the RF carrier frequency being used for the communications, and is using a similar antenna coupling. Therefore, any mechanism which adequately changes the signal path, set of paths, or coupling characteristics forming the communication link will cause a different CIR to be measured between the primary communicators and by a third party with a high probability.

Under this embodiment, the path set at either or both transceiver 300, 400 is changed so that the variations in the CIR occur more often per unit of time. Alternatively, multiple path sets between the transceivers 300 and 400 are exploited. Since each path set has its own CIR, security bits may be uniquely determined for each path set instance. A path set may contain only one path.

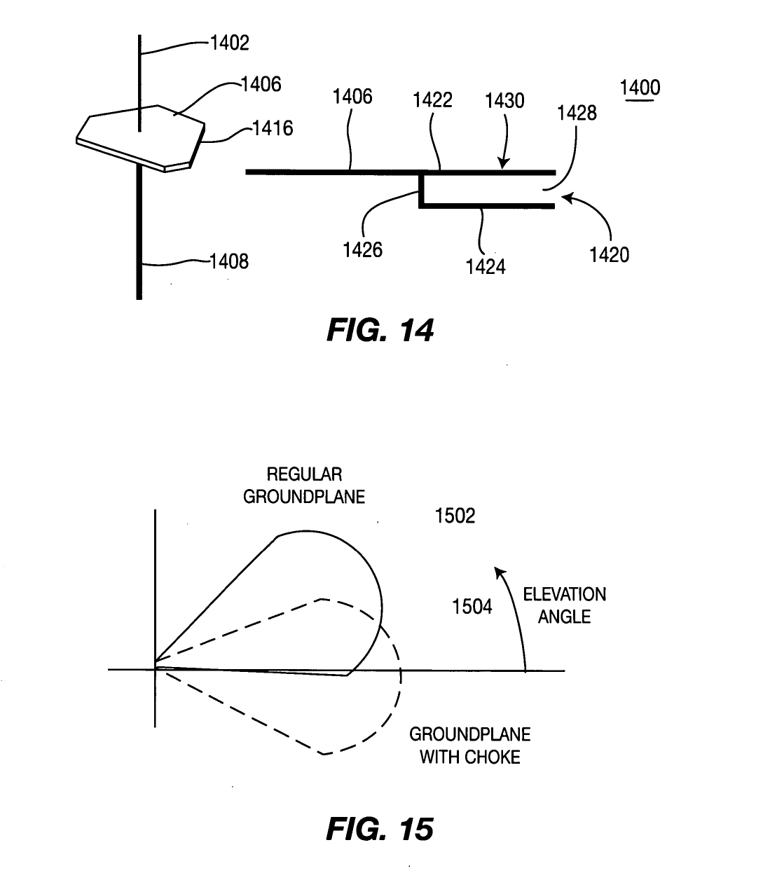

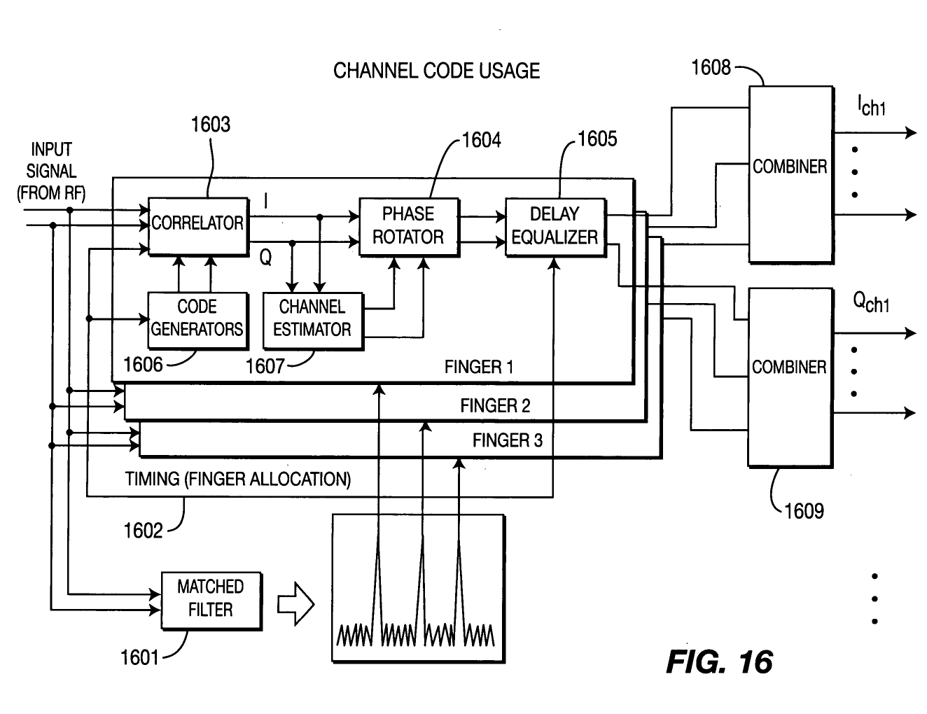

The general means for changing the path set is by changing the antenna array coupling to the RF medium. Changing said coupling will under the correct conditions change the path set affecting the communication link. Additionally, modification of the coupling via beam forming control may be applied, along with the following additional means:
1. Array deflection—an array can have one (SISO) or more active antenna elements. Copending and jointly owned U.S. patent application Ser. No. 11/065,752 filed on Feb. 25, 2005, is an example of several means for implementing such a deflection and is included in this disclosure in its entirety by reference. FIG. 14 shows one of the means 1402 disclosed therein to deflect an array. The choke impedance in the ground plane cavity 1428 is selectively changed, which causes an elevation change in antenna beam elevation angles 1502, 1504 as shown in the example of FIG. 15. One use would be to deflect the array pattern towards the ground.
2. Polarization selection—changes the dominance of one path over another.
3. Pattern deformation—array element loading, nanotechnology changes in dielectric, MEMS, etc. The change in the pattern in two or three dimensions makes changes in the path or paths affecting the measured CIR.
4. Path selection—FIG. 15 shows a beam forming as one approach. A time correlation selection is a second approach: e.g. specific CDMA path determined by time shifted matched filter. FIG. 16 shows a block diagram of a receiver 1600, which is a CDMA implementation of the time correlation selection approach. A time shifted matched filter 1601 derives path Fingers 1, 2 and 3. Timing signal 1602 drives I and Q correlator 1603, code generator 1606 and delay equalizer 1605. In a classical RAKE receiver, all the paths determined by the fingers would be combined and the output of the I and Q combiners 1608, 1609 would be one signals stream for each. For the purposes of this invention, the outputs of Finger 1, Finger 2, Finger 3 are preferably kept separate so that each I and Q value with the same delay equalizer 1605 value pair identifies the same RF path. Each path has its own set of CIR values derived by the channel estimator 1607 and provides its owns security bits to the aggregate. In some cases this may not be possible due to insufficient signal to noise ratio, and some of the paths may need to be combined, resulting in fewer paths being uniquely exploited by the CIR.

In general, all means described in this embodiment have to do with either changing the paths between the transceivers 300 and 400, selecting an existing different path between them, or modifying the characteristics of the coupling between the antenna array and the paths. The means can be applied at either transceiver 300, 400 or both. Different means can be applied at each transceiver 300, 400. Thus there are many permutations that could be utilized, each of which provides its own security bits.

A basic implementation selects one coupling means at each transceiver 300, 400 and utilizes its security derivable bits. The changing of the coupling means at one or both transceivers 300, 400 occurs only when the security bits fall below some predetermined threshold, or as part of a regular search for a more useful implementation.

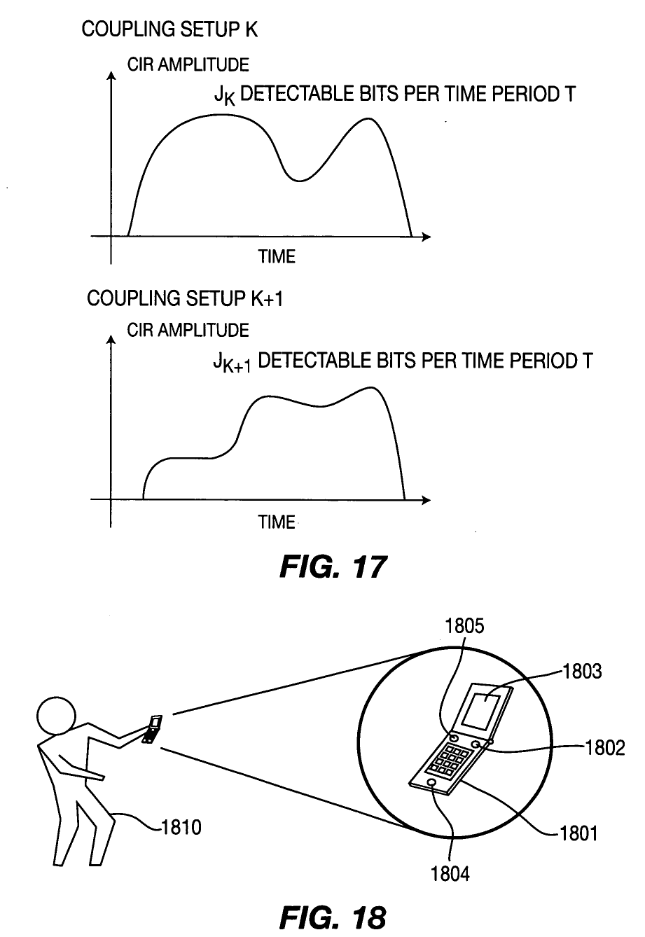

A more involved implementation purposely changes couplings on a regular basis. This is advantageous when the CIR correlation time for any specific coupling setup is inadequate (i.e., the number of detectable bits within a particular time period is inadequate to establish a secret key using JRNSO). FIG. 17 shows two different antenna coupling setups providing two CIRs with acceptable minor correlation, the correlation measured in terms of J detectible bits per time period T. Using the CDMA method they could represent two different paths measured simultaneously. For deflection method implemented via the referenced patent application, each coupling occurs during a time instance. By rotating through the coupling setups at a rate at least two times faster than the correlation time period of the fastest changing setup, the CIR contour for both setups can be determined. In either the parallel or sequential time measurement cases the bits available for security usage becomes Jₖ+Jₖ₊₁. This is trivially extensible to some value N of uncorrelated coupling setups:

$${\sum }_{k = 1}^{N} {J}_{k} .$$

Gesture-based JRNSO

A gesture-based JRNSO embodiment of the present invention utilizes the uniquely random characteristics exhibited by a user's movement of arms and limbs while handling a mobile communication device. These characteristics are unique enough to enable very reliable authentication of the user for access to the device functions. For example, when using a signature based authentication, it is not the written imprint which is used to authenticate an individual but rather the stroke, motion, direction and orientation of the pen on and off a tablet which provides the unique characteristics of the individual according to this embodiment of the present invention. In a similar manner, gestures made by an individual can also categorize or uniquely identify an individual. For example, the way in which an individual writes a letter or word in mid-air can be as unique as a signature.

In addition to the above described authentication, the gesture based movements also provide a capability to generate JRNSO bits at a high enough rate to enable secure communications between a device and a network. This is because such movement induces a faster time-varying randomizing effect on the RF paths at the WTRU, compared to the case when the human user is using the mobile WTRU in an effectively stationary position (e.g. sitting, or standing position), such that the JRNSO CIR measurements will yield more random bits per a fixed time period. Furthermore, the unique combination of the attributes used to authenticate the user to the device and the JRNSO bits generated can be combined to authenticate the user and the device uniquely to the network.

The rate at which JRNSO bits can be generated can be increased dramatically if there exists motion between the device and the network such that the motion changes the distance between the two nodes through more than at least half a wavelength. For the frequencies at which wireless systems operate, the wavelength is about 30 cm or less. Typical hand movement and gestures would easily vary the separation distance by more than half a wavelength and thus generate the desired number of secret bits through the JRNSO technique.

FIG. 18 shows a block diagram of a wireless communication device 1801, comprising a device controller 1802, which decides on a gesture sequence and instructs a human user 1810 to perform the action visually via text or pictorially on a display 1803 or via an audio speaker 1804, or a combination thereof. The device controller 1802, for example, could instruct the human user 1810 to perform the same sequence of gestures every time the user attempts to authenticate to the device 1801.

Alternatively, the device controller 1802 randomly chooses a sequence of motions from a table of gesture motion sequences stored in a memory 1805 (e.g., in the form of a look-up table), and then instructs the human user 1810 to perform the chosen motion. Thus, every time the human user 1810 wants to be authenticated to the device 1801, the user is prompted to perform a sequence of gesture motions that is selected by the device controller in a random way from a given dictionary. Such a randomized gesture-sequence selection has an added benefit of making it more difficult for an external party to observe and decipher the motion sequence and derive any side information about the motion sequence itself or the resultant effects on the JRNSO processing and the secret bits it will generate.

Note also that the indication of the selected motion sequence from the mobile device to the human user 1810 does not have to be done in one message. If desired, the indication can be conveyed in a sequence of sub-motions to the human user 1810. In such a case, the motion sequence index will be further encoded as a sequence of sub-motions, each of which is displayed sequentially to the human user 1810, so that the he will be able to perform a series of shorter-duration motions, each of which is indicated separately, rather than have to memorize and perform a long sequence of motions.

The invention also relies on the inclusion of a motion detector 1806 within the device 1801 to record movement of the device 1801 . This may be through refinement of the GPS navigation capabilities becoming common in wireless devices or through inclusion of an accelerometer or gyroscope. The user is then prompted with a series of prompts to perform some form of gesture(s). The prompts may be to write out a word or words or draw a figure in mid-air or a series of prompts and a measure of the responses. The motions are then recorded and processed to extract a model of the movement and this is then compared with a pre-stored expected representation in a similar way to signature recognition. At the same time, the motion also introduces sufficient movement between the device and the network to generate mutual secrecy bits which may be used to secure the communication between the device and the network.

These secrecy bits together with the authentication credentials may be used to positively authenticate the user to the device and the network while at the same time securing the communications to the network.

Additionally, the JRNSO bits generated from the performance of the instructed gesture are preferably used for enhancing the security of any authentication procedures being implemented by the communication system. Such authentication procedures include the Authentication and Key Agreement (AKA) procedures used in UMTS cellular communication systems, and the Extensible Authentication Protocol (EAP) procedures used in 802.11 i wireless LAN standards.

The JRNSO secret key generated from the gesture-motion procedure is used to encrypt and decrypt some or all of the authentication protocol messages that are exchanged in the Transport-Layer Security (TLS) protocol exchange whereby the Wireless Network and the Mobile Device mutually authenticate each other. Thus, encryption of the authentication protocol messages using the commonly shared JRNSO keys strengthens the security of the existing scheme. The JRNSO based secret bits may also enable separation of the authentication from the session keys used for ciphering and integrity processing and thus decouple the session keys completely from the authentication.

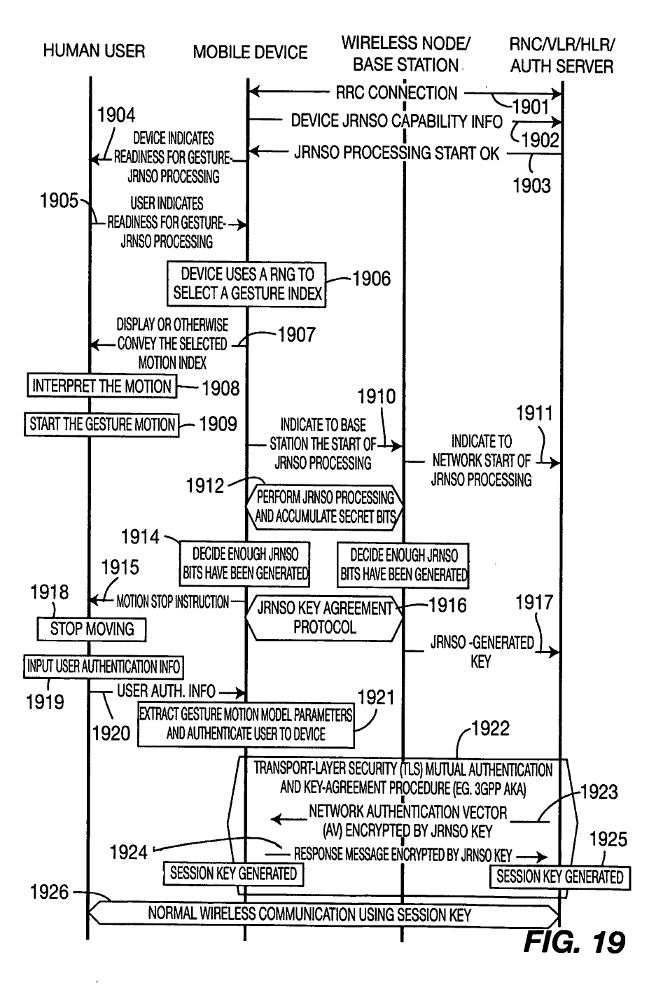

FIG. 19 shows a diagram of an embodiment of the proposed method as applied to authentication of a human user and Device to the Cellular wireless network. The Mobile Device in this case would be a cellular phone which is capable of performing JRNSO processing as well as the procedures involved with deciding and instructing on the gesture sequence to the human user which would in this case be the cellular phone user. The authentication is assumed to employ multiple authentication factors, with the extracted model parameters from the gesture being one factor and the JRNSO generated secret bits aiding secure communications. Also, the random motion sequence selection as described above is assumed to be employed in this example. In this example, the motion sequence is indexed. A random number generator (RNG) is assumed to exist in the Mobile Device and is used to generate a random number to be used as the index for the gesture motion sequence. Also, the motion sequence index is assumed to be conveyed to the human user as one index, which will then be described to the human user once, in this example.

Note that, in this example, the existing authentication factors are encrypted by the JRNSO bits at the Mobile Device, transmitted to the wireless node, and then decrypted by the wireless node using the shared JRNSO secret bits. Thus, in this embodiment the use of the JRNSO secret bits are cryptographically integrated with the use of the other authentication factor(s).

Note also that, in this example, use of the gesture-based JRNSO encryption for the authentication of the Wireless Network to the Mobile Device is also proposed.

The Authentication Vector (AV) used in an existing Transport-Layer Security (TLS) protocol (e.g., the 3GPP Authentication and Key Authorization (AKA) protocol), for the mutual authentication between the Mobile Device and the Wireless Network, is encrypted using the JRNSO keys generated by the gesture motion. In this fashion, the authentication procedures for the Network and Mobile Device are strengthened by the use of the JRNSO secret bits induced by the gesture motion.

The above methods may be implemented in a wireless transmit/receive unit (WTRU), base station, WLAN STA, WLAN AP, and/or peer-to-peer devices. This includes WTRU 220, AP205, AP210, AP215, transceiver 300 and 400, transmitter 500, receiver 600, transmitter 901, receiver 902, the eigen-beamforming units 1002, 1004, receiver 1600 and mobile device 1801. The above methods are applicable to a physical layer in radio or digital baseband, a session layer, a presentation layer, an application layer, and a security layer/cross-layer design (security in the physical layer). The applicable forms of implementation include application specific integrated circuit (ASIC), digital signal processing (DSP), software and hardware.

What is claimed is:

1. A wireless communication system for securing wireless communications, the system comprising:
a wireless transmit/receive unit (WTRU);
a first access point (AP) for transmitting a first portion of a bit stream to the WTRU; and
a second AP for transmitting a second portion of the bit stream to the WTRU, wherein the WTRU is located in an area where a transmission pattern radiated from each of the first and second APs intersect, and the WTRU reassembles the first and second portions into the bit stream.

2. The system of claim 1 wherein it is not possible to receive both of the portions of the bit stream at a location outside of the area where transmission patterns of the first and second APs intersect.

3. The system of claim 1 wherein the first portion of the bit stream is incorporated in a first packet data unit (PDU), the second portion of the bit stream is incorporated in a second PDU and the WTRU reassembles the first and second PDUs into a service data unit (SDU).

4. The system of claim 1 wherein the WTRU reports the location of the WTRU to each of the APs and the APs transmit a sequence of messages at varying effective coding rates which request a positive acknowledgement (ACK) or a negative acknowledgement (NACK) from the WTRU, such that the APs can determine whether the location of the WTRU is correct.

5. The system of claim 4 wherein the APs determine whether the WTRU can decode transmissions sent by the APs.

6. The system of claim 4 wherein the APs verify the authenticity of the WTRU by sending a challenge question via a plurality of packet data units (PDUs) to the WTRU such that the challenge question would be decipherable by the WTRU and answered by the WTRU only if the WTRU is located at the location reported by the WTRU.

7. A wireless communication system for securing wireless communications, the system comprising:
a wireless transmit/receive unit (WTRU);
a first access point (AP) for transmitting a first packet data unit (PDU) to the WTRU; and
a second AP for transmitting a second PDU to the WTRU, wherein the WTRU is located in an area where a transmission pattern radiated from each of the first and second APs intersect, and the WTRU performs a function on the first and second PDUs to derive a service data unit (SDU).

8. The system of claim 7 wherein it is not possible to receive both of the first and second PDUs at a location outside of the area where transmission patterns of the first and second APs intersect.

9. The system of claim 7 wherein the function is an exclusive-or (XOR) function.

10. The system of claim 7 wherein the WTRU reports the location of the WTRU to each of the APs and the APs transmit a sequence of messages at varying effective coding rates which request a positive acknowledgement (ACK) or a negative acknowledgement (NACK) from the WTRU, such that the APs can determine whether the location of the WTRU is correct.

11. The system of claim 10 wherein the APs determine whether the WTRU can decode transmissions sent by the APs.

12. The system of claim 10 wherein the APs verify the authenticity of the WTRU by sending a challenge question via a plurality of packet data units (PDUs) to the WTRU such that the challenge question would be decipherable by the WTRU and answered by the WTRU only if the WTRU is located at the location reported by the WTRU.

13. A method for encryption of a high data rate communication data stream, comprising:
generating a truly random key using a channel impulse response of a joint channel;
generating a pseudo random bit stream of equal bit rate as the data stream, the pseudo random bit stream generated using a pseudo-random function; and
applying the pseudo random bit stream to the data stream using a bit-wise XOR function.

14. The method of claim 13, in which the truly random key generator is a JRNSO bit generator.

15. The method of claim 13 in which the pseudo-random function is a cipher.

16. The method of claim 15, wherein the cipher is an advanced encryption standard (AES) block cipher.

17. The method of claim 16, further comprising:
ciphering a non-trivially repeating nonce using a strong key; and
changing the strong key every time a new one is available.

18. The method of claim 17 wherein the strong key is a joint randomness not shared by others (JRNSO) shared bit string.

19. The method as in claim 13, further comprising:
generating an MK nonce, where M blocks of pseudo-random bits are combined with a block of K bits of truly random data, the K bits used as a starting key for M iterations.

20. The method as in claim 13, wherein the communication is a CDMA signal that uses the pseudo-random bit stream produced by the pseudo-random function as its scrambling code.

21. A method for encoding a communication data stream, comprising:
selecting an interleaving function from among a set of interleaving functions according to a joint randomness not shared by others (JRNSO) shared string of bits; and
encoding the communication data stream using the interleaving function.

22. The method of claim 21, in which the interleaving function is changed when a new string with a sufficient number of JRNSO bits is available.

23. The method of claim 21, in which a first party and a second party communicate, and both parties generate truly random bits synchronously.

24. The method of claim 21, in which publicly known pseudo-random bits are generated, further comprising:
combining the publicly generated pseudo-random bits with a set of the JRNSO bits when a sufficient number of JRNSO bits are available; and
selecting a new candidate interleaver based on the combining of pseudo random bits and the JRNSO bits.

25. A method for encoding a communication data stream, comprising:
generating truly random bits using a JRNSO procedure;
using a maximum length shift register (MLSR) sequence generator with n-bit states to generate non-zero elements for a given Galois Field GS(2ⁿ);
defining an interleaving function by a mapping from a predefined indexing of the non-zero Galois Field elements to the order in which they are generated; and
encoding the communication data stream using the interleaving function.

26. The method of claim 25, wherein the starting phase of the MLSR sequence generator is determined by the truly random bits.

27. The WTRU of claim 26 wherein selection of a new interleaver function is started once enough truly random bits are available to seed the MLSR sequence generator.

28. The method as in claim 25, further comprising modulating in which the encoding of the communication data stream is applied prior to modulation for transmission.

29. A wireless transmit/receive unit (WTRU) configured for encryption of a high data rate communication data stream, comprising:
a truly secret key generator configured to generate a truly random key using a channel impulse response of a joint channel;
a pseudo-random function processor configured to generate a pseudo random bit stream of equal bit rate as the data stream, the pseudo random bit stream generated according to a pseudo-random function; and
a one time pad unit configured to apply the pseudo random bit stream to the data stream using a bit-wise XOR function.

30. The WTRU of claim 29, in which the truly random key generator is a JRNSO bit generator.

31. The WTRU of claim 29 in which the pseudo-random function is a cipher.

32. The WTRU of claim 31, wherein the cipher is an advanced encryption standard (AES) block cipher.

33. The WTRU of claim 32, in which a non-trivially repeating nonce is ciphered using the strong key and the strong key is changed every time a new one is available.

34. The WTRU of claim 33 wherein the strong key is a joint randomness not shared by others (JRNSO) shared bit string.

35. The WTRU as in claim 29, wherein an MK nonce is generated, where M blocks of pseudo-random bits are combined with a block of K bits of truly random data, and the K bits are used as a starting key for M iterations.

36. The WTRU as in claim 29, wherein the communication is a CDMA signal that uses the random bit stream produced by the pseudo-random function as its scrambling code.

37. A WTRU configured for encoding a communication data stream, comprising:
a processor configured to select an interleaving function from among a set of interleaving functions according to a joint randomness not shared by others (JRNSO) shared string of bits and to encode the communication data stream using the interleaving function.

38. The WTRU of claim 37, in which the interleaving function is changed when a new string with a sufficient number of JRNSO bits is available.

39. The WTRU of claim 37, in which a first party and a second party communicate, and both parties generate random bits synchronously.

40. The WTRU of claim 37, in which publicly known pseudo-random bits are generated, wherein the processor is further configured to combine the publicly generated pseudo-random bits with a set of the JRNSO bits when a sufficient number of JRNSO bits are available; and select a new candidate interleaver based on the combining of pseudo random bits and the JRNSO bits.

41. A WTRU for encoding a communication data stream, comprising:
a JRNSO generator configured to generate truly random bits using a JRNSO procedure;
a maximum length shift register (MLSR) sequence generator with n-bit states configured to generate non-zero elements for a given Galois Field GS(2ⁿ);
an interleaving processor configured to define an interleaving function by a mapping from a predefined indexing of the non-zero Galois Field elements to the order in which they are generated to encode the communication data stream using the interleaving function.

42. The WTRU of claim 41, wherein the starting phase of the MLSR sequence generator is determined by the truly random bits.

43. The WTRU of claim 42 wherein selection of a new interleaver function is started once enough truly random bits are available to seed the MLSR sequence generator.

44. The WTRU as in claim 42, further comprising an encoder configured to perform encoding of the communication data stream prior to RF modulation for transmission.

45. A method for amplifying channel randomness for enhancement of a message encryption, comprising:
employing a symmetric block cipher in which one secret key is used to both encrypt and decrypt the message; and
applying a joint randomness not shared by others (JRNSO) shared bit string for a secret key update on a block of plaintext data input using a bitwise XOR operation.

46. The method according to claim 45 in which the symmetric block cipher is in accordance with an advanced encryption standard (AES).

47. The method according to claim 45 in which the secret key update occurs each time a new string of bits equal in size to the length of the secret key is available for encryption.

48. A method for amplifying channel randomness for enhancement of a message encryption, comprising:
applying a public key cryptosystem encryption according to a key having public and private elements; and
applying available JRNSO secret bit strings to encrypt the public elements using an XOR operation.

49. The method according to claim 48, in which the public key cryptosystem encryption is according to an RSA approach.

50. The method according to claim 48, in which encryption is according to the following equation: y=e_{K}(x)=x^{b} mod n and decryption is according to the following equation: x=d_{K}(y)=y^{a} mod n , where x is plaintext and y is ciphertext, the key K={n,p,q,a,b}, where n=pq , n and b are public and a, p and q are private.

51. The method according to claim 49, in which p and q are prime numbers and a and b satisfy the following invertibility condition:
ab=1 mod(p−1)(q−1).

52. A method for authenticating a first party to a second party, comprising the steps of:
sharing a JRNSO secret bit sequence between the first party and the second party;
computing a value of a first function by the first party using a portion of the secret bit sequence and a secret underlying value;
exchanging the value of the first function between the first party and the second party;
computing a value of a second function by the second party using the portion of the secret bit sequence and the value of the first function; and
computing a value of a third function by the second party using the value of the second function, whereby the third function is used to verify the secret underlying value.

53. The method according to claim 52, wherein the entire secret bit sequence is used in computing the value of the first function and the value of the second function.

54. The method of claim 52, wherein the first party is a first node in a wireless communication network and the second party is a second node in the wireless communication network, whereby the identity of the first node is verified as the secret underlying value.

55. The method according to claim 54, wherein all packets sent from the first node to the network are blocked by the second node until the first node is verified.

56. In a database system that includes a management system and an implementation of a JRNSO mechanism whereby random information is extracted from a layered communication system, a method for secure protection of database stream information, comprising:
generating a secret key from a joint channel characteristics by the JRNSO mechanism;
supplying every with the secret key generated between a remote client and a server; and
extracting the secret key by the database management system.

57. The method of claim 56, further comprising using the secret key to encrypt the data returned from the database and transmitting the encrypted data by the database server to the remote user.

58. In a database system that includes a database management system (DBMS) and an implementation of a JRNSO mechanism whereby random information is extracted from an Operating System and used to establish and continuously update the keying mechanism applied, a method for database information secure protection, comprising:
locally accessing the database server by an application;
using a random electrical characteristic associated with an internal communication bus to generate a JRNSO secret key between the application and database;
using the secret key to authenticate the application and grant it access to the database server.

59. The method of claim 58, further comprising the application supplying the secret key, protected with public certificates to authenticate itself.

60. The method of claim 59, further comprising the DBMS using the secret key as a secure token and verifying with the version of the key available to itself.

61. The method of claim 60, further comprising the DBMS encrypting the data to be returned with the secret key to the requesting application.

62. In a sensor network that exchanges streaming data between network nodes, a method for protection of the streaming data comprising:
every node sending data continuously to a central server;
extracting random information from the user data;
generating a JRNSO secret key based on the random information; and
encrypting the transmitted data from each node using the secret key.

63. The method of claim 62, wherein the random information includes one or more of the following characteristics: user location, an electrical characteristic, a physical characteristic, battery life, and signal strength.

64. In a wireless communication system of at least two MIMO stations, a method for creating subchannels using eigen-decomposition for increased randomization of a wireless channel between the stations, comprising:
using singular value decomposition (SVD) of a channel matrix H, where H represents the channel taps of antenna elements of the MIMO channel, as a function of unitary eigenvectors U, V, and a diagonal matrix of real values;
decomposing the wireless channel into eigen-modes, each eigen-mode represented by a corresponding eigen-value;
observing for each eigen mode, a distribution of eigen-values across channel frequency with respect to SNR and frequency dispersiveness; and
selecting a dominant eigen-mode having highest SNR for data communication and one or more weaker eigen-modes having highest variability in frequency dispersion for increased generation of randomness for a JRSNO secret key.

65. The method according to claim 64, wherein a transmitting MIMO station uses eigenvector V for eigen-beamforming, where V is a right unitary matrix containing right singular vectors of H; and wherein a receiving MIMO station uses eigenvector U for eigen-beamforming, where U is a left unitary matrix containing left singular vectors of H.

66. A method as in claim 64, in which the smallest eigen-mode has a Rayleigh fading statistic, while stronger modes have respectively narrower distributions.

67. A method as in claim 64, wherein the antennas are adaptive, further comprising:
steering an antenna beam so that the transmitted signal reflects to create the highest possible random variation into the channel.

68. The method of claim 67, wherein the antennas are pointed toward the ground to create reflections off the ground.

69. The method according to claim 68, further comprising:
selecting an antenna beam according to a trade off between the random variation and data throughput.

70. The method according to claim 68, further comprising:
using separate sets of antenna beams for random variation and data throughput, such that a first set of antenna beams is configured to optimize random variation and a second set of antenna beams is configured to optimize data throughput, where each set comprises one or more antenna beams.

71. The method according to claim 70, wherein a SISO station communicates with one of the MIMO stations, further comprising:
using a plurality of pilot signals on either set of antenna beams such that the first set and the second set of antenna beams can be distinguished when received by the SISO station.

72. The method according to claim 71, wherein the pilot signals are selectively pre-delayed.

73. The method according to claim 71, wherein the pilot signals use different sequences such that different pilot sequences are used on different antenna beams.

74. A method for enhancing randomness in a joint channel between a first transceiver and a second transceiver such that a secret key for encryption of a communication between the first and the second transceivers can be generated, comprising:
altering the path of the communication channel at either or both of the first and the second transceiver such that a channel impulse response (CIR) is affected;
generating a random set of bits based on the CIR to form a JRNSO based secret key, whereby the secret key bits are independently generated at each of the transceivers; and
encrypting the communication between the first and the second transceivers using the secret key.

75. The method of claim 74, in which the altering is achieved by deflection of an antenna array such that a choke impedance on an antenna ground plane is selectively changed, thereby changing antenna beam elevation angles.

76. The method of claim 75, wherein the deflection of the antenna beam is toward the ground.

77. The method of claim 74, in which the altering is with respect to selection of polarization path dominance.

78. The method of claim 74, in which the altering is with respect to changing array element coupling to the RF medium.

79. The method of claim 78, in which the antenna element loading is changed to affect transmit pattern deformation in two or three dimensions, thereby affecting the CIR measurements.

80. The method of claim 74, wherein the communication is CDMA-based, further comprising determining a specific CDMA path by using a time shifted matched filter.

81. The method of claim 80, wherein a RAKE receiver is used, further comprising:
keeping outputs from each RAKE finger separate for each I and Q value so that multiple RF paths can be identified;
deriving a separate set of CIR values for each identified RF path; and
using the CIR values for generating the JRNSO secrecy bits.

82. The method of claim 74, wherein the altering occurs only when the number of security bits falls below a predetermined threshold.

83. The method of claim 74, wherein the altering occurs when a CIR correlation time between the first and the second transceiver is longer than a predetermined threshold.

84. A method for enhancing shared randomness in a joint channel for authentication and encryption of a wireless communication signal between a mobile communication device used by a human user and a second communication device, comprising:
gesturing by the human user such that the mobile device is moved to an extent that a change in distance to the second communication device is about half of a signal wavelength;
measuring a CIR of the channel to generate a set of random bits;
using the random set of bits to generate a JRNSO secret key; and
encrypting the communication channel using the secret key.

85. The method of claim 84, further comprising providing an instruction to the human user as to which gesturing is preferred.

86. The method of claim 85, wherein the instruction is visual or audio or both.

87. The method of claim 85, wherein several instructions are stored in a memory and one instruction is randomly selected.

88. The method of claim 84, further comprising:
observing movements of the mobile communication device caused by a human user's gestures while handling the mobile communication device; and
using the unique movements for authenticating the user to the access the device functions.

89. The method of claim 84, further comprising:
observing movements of the mobile communication device caused by a human user's gestures while handling the mobile communication device; and
using the unique movements for authenticating the user to the network to allow access to a communication network.
